(19) United States
(12) Patent Application Publication
(10) Pub. No.: US 2024/0092993 A1
(43) Pub. Date: Mar. 21, 2024

(54) ORGANOMETALLIC COMPOUND INCORPORATED WITHIN EXISTING SULFUR CROSS-LINKED RUBBER MORPHOLOGY

(71) Applicant: William B. Coe, Wrightwood, CA (US)

(72) Inventor: William B. Coe, Wrightwood, CA (US)

(21) Appl. No.: 18/493,573

(22) Filed: Oct. 24, 2023

Related U.S. Application Data
(63) Continuation of application No. PCT/US2022/023727, filed on Apr. 6, 2022.
(60) Provisional application No. 63/263,559, filed on Nov. 4, 2021.
(60) Provisional application No. 63/222,084, filed on Jul. 15, 2021.
(60) Provisional application No. 63/181,078, filed on Apr. 28, 2021.

(51) Int. Cl. C08J 11/26; C08K 3/06; C08K 3/30; C08K 5/56; C08L 19/00; C08L 95/00

(52) U.S. Cl. CPC C08J 11/26; C08K 3/06; C08K 3/30; C08K 5/56; C08L 19/003; C08L 95/00; C08J 2321/00; C08K 2003/3009; C08L 2555/34

(57) ABSTRACT

An organometallic compound is incorporated into a vulcanized rubber matrix. A tunable, multi-phase copper sulfide lattice is compounded within an existing sulfur cross-linked morphology, as in crumb rubber obtained from recycled tires or other vulcanized rubber, whereby thermotropic properties of the rubber matrix are modulated. The process involves breaking of sulfur-sulfur and/or sulfur-carbon bonds through action of the carbon sulfide. The resulting rubber is suitable for use in applications typically utilizing virgin rubber, such as new tires, engineered rubber articles, and asphalt rubber for use in waterproofing and paving applications. In other embodiments, an organometallic compound comprising iron acetate or alkaline earth metal acetate is incorporated into the vulcanized rubber matrix.

### CROSS-REFERENCE TO RELATED APPLICATIONS

Any and all priority claims identified in the Application Data Sheet, or any correction thereto, are hereby incorporated by reference under 37 CFR 1.57. This application is a continuation of PCT International Application No. PCT/US2022/023727, filed Apr. 6, 2022, which claims the benefit of U.S. Provisional Application Ser. No. 63/181,078, filed Apr. 28, 2021, entitled TUNABLE, MULTI-PHASE COPPER SULFIDE LATTICE COMPOUNDED WITHIN EXISTING SULFUR CROSS-LINKED RUBBER MORPHOLOGY; U.S. Provisional Application Ser. No. 63/222,084, filed Jul. 15, 2021, titled TUNABLE, MULTI-PHASE COPPER SULFIDE LATTICE COMPOUNDED WITHIN EXISTING SULFUR CROSS-LINKED RUBBER MORPHOLOGY; and U.S. Provisional Application Ser. No. 63/263,559, filed Nov. 4, 2021, titled ORGANOMETALLIC COMPOUND INCORPORATED WITHIN EXISTING SULFUR CROSS-LINKED RUBBER MORPHOLOGY. Each of the applications listed above is expressly incorporated by reference herein in its entirety.

### FIELD

An organometallic compound (OMC) is incorporated into a vulcanized rubber matrix. A tunable, multi-phase copper sulfide lattice is compounded within an existing sulfur cross-linked morphology, as in crumb rubber obtained from recycled tires or other vulcanized rubber, whereby thermotropic properties of the rubber matrix are modulated. The process involves breaking of sulfur-sulfur and/or sulfur-carbon bonds through action of the carbon sulfide. The resulting rubber is suitable for use in applications typically utilizing virgin rubber, such as new tires, engineered rubber articles, and asphalt rubber for use in waterproofing and paving applications. In other embodiments, an organometallic compound comprising iron acetate or alkaline earth metal acetate is incorporated into the vulcanized rubber matrix.

### BACKGROUND

In 2015, end-use markets consumed 87.9% percent by weight of the scrap tires generated in the U.S. The total volume of scrap tires consumed in end use markets in the U.S. reached approximately 3551 thousand tons of tires. RMA estimates that about 4038 thousand tons of tires were generated in the U.S. in 2015. Of those tires, 25.8% were used to produce ground rubber, 48.6% for tire derived fuel, 11.4% were land disposed, 7.0% were used in civil engineering, and 7.1% went to miscellaneous uses (0.7% to electric arc furnace, 1.3% to reclamation projects, 2.6% were exported, and 2.6% went to other uses). In 1990, only eleven percent of tires were consumed on a per tire basis. Positive end-use market results in 2015 were primarily the result of high rates of TDF use and lower exports. In the long term, the need to expand all economically viable and environmentally sound markets for scrap tires is still an imperative. Scrap tires were consumed by a variety of scrap tire markets, including tire-derived fuel, civil engineering and ground rubber applications. Other smaller markets and legal landfilling consumed the remaining annually-generated tires.

Key scrap tire markets include tire derived fuel, ground rubber, civil engineering and other markets. In tire derived fuel applications, scrap tires are used as a cleaner and more economical alternative to coal as fuel in cement kilns, pulp and paper mills and industrial and utility boilers. Ground rubber applications utilize approximately 1020 thousand tons of scrap tires, or over 25 percent of the volume of scrap tires generated each year. Ground rubber is produced by grinding scrap tires into size defined pieces. Ground rubber applications include new rubber products, playground and other sports surfacing and rubber-modified asphalt. Ground rubber also includes larger pieces of rubber used as landscaping mulch, and loose fill playground material. The playground and mulch market were the most dynamic segment in the ground rubber market during this period. The asphalt market uses ground rubber to modify the asphalt binder used in road paving, resulting in quieter, more durable roads. The civil engineering market consumes approximately 274 thousand tons of tires per year, about 7.7 percent of the total tires to market, and consists of tire shreds used in road and landfill construction, septic tank leach fields, alternative daily cover and other construction applications. Additional smaller markets for scrap tires exist that consume approximately 7% of annually generated scrap tires. These markets include tires consumed in electric arc furnaces (steel manufacturing), professionally engineered tire bales and products punched, pressed, or stamped from scrap tires. Total tire rubber consumed in ground rubber markets is about 1.36 billion pounds. The total scrap tires diverted to these ground rubber markets is about 1.02 million tons (62 million tires). The percent of total pounds of ground rubber consumed in the market in 2015 is as follows: sport surfaces 25%, playground mulch 22%, molded/extruded products 35%, asphalt 15%, automotive uses 2%, and export 1%.

Stockpiles of scrap tires historically began to be created around the 1960s and 1970s when tires were diverted from landfills, but recycling markets for them were not functional. Stockpiles proved to be prone to catastrophic fires which created air and water pollution.

Worldwide rubber tire production is responsible for generating approximately 99% of worldwide, end-of-life (EOL) tire scrap. About 1.1 billion scrap tires are generated annually, corresponding to roughly 12 million tons of scrap tire. Due to the punishing physical properties required of a new tire, tires embody a carefully engineered weaving together of steel and fiber cords with a mineral and carbon-filled rubber blend, all cross linked to a highly tenacious structure. The EOL tire is challenging to breakdown to its original essential elements. The potentially highest value component—the rubber—is particularly difficult to reclaim, due to the vulcanization process it is subjected to. As a result, EOL tires that are no longer suitable for use on vehicles due to wear or irreparable damage are typically either subject to pyrolysis (e.g., to generate energy for use in cement manufacturing), or ground up to be used as filler (e.g., in asphalt pavement, new tires, construction or landscaping materials).

### SUMMARY

Extensive research efforts over many years have been devoted to development of methods for devulcanizing vulcanized rubber, e.g., tire rubber, so as to transform tire rubber into a commercially viable product having properties similar to virgin composite rubber. These efforts have generally met with limited success, until the recent development of methods as documented in PCT Publ. No. WO 2018/200340, PCT Publ. No. WO 2019/135815, and PCT Publ. No. WO 2019/028286. The present methods provide an improvement to these processes and compositions, enabling the processes to be conducted with greater environmental safety. to yield products of desirable physical properties, and/or to enable the process to be conducted in a more cost-efficient manner.

One of the objects of the methods described herein is to process, with greater efficiency and/or cost effectiveness, vulcanized rubber products or other cross linked rubber containing products, e.g., as found in end-of-life (EOL) rubber tires, into a form suitable for use as a raw material in the fabrication of articles of manufacture that would conventionally be fabricated from virgin rubber subjected to vulcanization, e.g., new tires or other vulcanized rubber products. The vulcanized rubber subjected to the methods described herein is typically provided as a conventionally available, 30 mesh, end-of-life, ground tire rubber (GTR) particle (GTRP), or smaller particle size material. The methods described herein can be employed to transform EOL tire rubber into a rubber product (referred to variously herein as “PTR”) having desirable properties.

The Joint Research Council (JRC) for the EC recently published a Critical Raw Material (CRM) study in December 2017 listing 27 materials subject to supply disruption; a disruption that would result in significant loss of economic sustainability. Natural rubber (NR) was listed as one of the 27 materials. The process disclosed herein can provide up to 70% of the natural rubber gap referred to in the CRM study.

Accordingly, in a generally applicable first aspect (i.e., independently combinable with any of the aspects or embodiments identified herein), a method is provided for preparing a rubber-based elastomer, comprising: applying pressure to a mixture comprising sulfur-crosslinked rubber particles and particles of a digenite lattice of copper sulfide, then releasing the pressure, whereby a resident sulfur in a rubber crosslink of the sulfur-crosslinked rubber particles is transferred to the digenite lattice of copper sulfide, whereby a rubber-based elastomer is obtained.

In an embodiment of the first aspect (i.e., independently combinable with any of the aspects or embodiments identified herein), the particles of the digenite lattice of copper sulfide are provided in a carrier comprising oleic acid ligand, and wherein the oleic acid ligand reduces the resident sulfur in the rubber crosslink prior to its transfer to the digenite lattice of copper sulfide.

In an embodiment of the first aspect (i.e., independently combinable with any of the aspects or embodiments identified herein), the oleic acid ligand is provided in a form of soy oil containing 22% by weight oleic acid component.

In an embodiment of the first aspect (i.e., independently combinable with any of the aspects or embodiments identified herein), the particles of the digenite lattice of copper sulfide and the carrier are mixed at a weight ratio of 1:4 prior to mixing with the sulfur-crosslinked rubber particles.

In an embodiment of the first aspect (i.e., independently combinable with any of the aspects or embodiments identified herein), the particles of the digenite lattice of copper sulfide are provided in a mixture with a stabilizer, optionally silica particles.

In an embodiment of the first aspect (i.e., independently combinable with any of the aspects or embodiments identified herein), the silica particles are nanoparticles of approx. 160 m²/g surface area.

In an embodiment of the first aspect (i.e., independently combinable with any of the aspects or embodiments identified herein), the particles of the digenite lattice of copper sulfide and the carrier are mixed at a weight ratio of 1:4 to yield an OMC-1, and wherein the OMC-1 is combined with the stabilizer at a weight ratio of 1:5 to yield a mixture of OMC-1 and stabilizer.

In an embodiment of the first aspect (i.e., independently combinable with any of the aspects or embodiments identified herein), the mixture of OMC-1 and stabilizer is combined with sulfur-crosslinked rubber particles in a weight ratio of 4:96.

In an embodiment of the first aspect (i.e., independently combinable with any of the aspects or embodiments identified herein), the sulfur-crosslinked rubber particles are in a form of ground tire rubber having an average particle size of approx. 600 microns.

In an embodiment of the first aspect (i.e., independently combinable with any of the aspects or embodiments identified herein), the ground tire rubber is end-of-life tire rubber.

In an embodiment of the first aspect (i.e., independently combinable with any of the aspects or embodiments identified herein), the particles of the digenite lattice of copper sulfide are provided in a mixture with a stabilizer, optionally silica particles.

In an embodiment of the first aspect (i.e., independently combinable with any of the aspects or embodiments identified herein), the particles of digenite lattice of copper sulfide are prepared by reacting metallic copper with sulfur at a temperature of 155° C. in a closed, vented ceramic vessel, and capturing escaping copper sulfide in an activated carbon filter, optionally subjecting the copper sulfide to hydro-quenching to achieve a particle size of <100 nm.

In an embodiment of the first aspect (i.e., independently combinable with any of the aspects or embodiments identified herein), the copper is 99% by weight pure copper metal in a form of wire or particles and wherein the sulfur is in a form of 99% by weight pure precipitated sulfur.

In an embodiment of the first aspect (i.e., independently combinable with any of the aspects or embodiments identified herein), the digenite lattice of copper sulfide is converted to a covellite phase of copper sulfide.

In a generally applicable second aspect (i.e., independently combinable with any of the aspects or embodiments identified herein), a method is provided for preparing a rubber-based elastomer, comprising: applying pressure to a mixture comprising sulfur-crosslinked rubber particles and iron (II) acetate, then releasing the pressure, whereby a rubber-based elastomer is obtained.

In an embodiment of the second aspect (i.e., independently combinable with any of the aspects or embodiments identified herein), the iron (II) acetate is present in the mixture at from 1 to 5% by weight of the mixture.

In an embodiment of the second aspect (i.e., independently combinable with any of the aspects or embodiments identified herein), the iron (II) acetate is present in the mixture at about 2% by weight of the mixture.

In an embodiment of the second aspect (i.e., independently combinable with any of the aspects or embodiments identified herein), the sulfur-crosslinked rubber particles are in a form of ground tire rubber having an average particle size of approx. 600 microns.

In an embodiment of the second aspect (i.e., independently combinable with any of the aspects or embodiments identified herein), the ground tire rubber is end-of-life tire rubber.

In an embodiment of the second aspect (i.e., independently combinable with any of the aspects or embodiments identified herein), the method further comprises preparing a mixture comprising the rubber-based elastomer and copper (II) acetate, applying pressure to the mixture of the rubber-based elastomer and copper (II) acetate, then releasing the pressure, whereby a reduced particle size rubber-based elastomer is obtained.

In an embodiment of the second aspect (i.e., independently combinable with any of the aspects or embodiments identified herein), the iron (II) acetate is present in the mixture comprising sulfur-crosslinked rubber particles and iron (II) acetate at about 1.5% by weight of the mixture, and wherein the copper (II) acetate is present in the mixture comprising rubber-based elastomer and copper (II) acetate at about 0.5% by weight of the mixture comprising rubber-based elastomer and copper (II) acetate.

In an embodiment of the first or the second aspect (i.e., independently combinable with any of the aspects or embodiments identified herein), the mixture is subjected to microwave radiation.

In an embodiment of the first or the second aspect (i.e., independently combinable with any of the aspects or embodiments identified herein), the pressure is generated into a co-rotating reactor, optionally a co-rotating reactor comprising an annular cavity wherein a series of rotating lobes create pressure impingement upon the mixture as it progresses through the co-rotating reactor.

In an embodiment of the first or the second aspect (i.e., independently combinable with any of the aspects or embodiments identified herein), the pressure is generated by co-rotating reactor compression bars adapted to subject the mixture to pressure pulses.

In an embodiment of the first or the second aspect (i.e., independently combinable with any of the aspects or embodiments identified herein), pressure is applied by passing the mixture through a multi-lobe, co-rotating mixer extruder.

In an embodiment of the first or the second aspect (i.e., independently combinable with any of the aspects or embodiments identified herein), pressure is applied in a series of pulses, wherein each particle of the mixture encounters 120,000 or more pulses in production of the rubber-based elastomer.

In an embodiment of the first or the second aspect (i.e., independently combinable with any of the aspects or embodiments identified herein), pressure is applied by passing the mixture between two rollers.

In an embodiment of the first or the second aspect (i.e., independently combinable with any of the aspects or embodiments identified herein), the mixture passes between the two rollers from 3 to 100 times.

In an embodiment of the first or the second aspect (i.e., independently combinable with any of the aspects or embodiments identified herein), the mixture passes between the two rollers from 3 to 10 times.

In an embodiment of the first or the second aspect (i.e., independently combinable with any of the aspects or embodiments identified herein), the mixture passes between the rollers from 3 to 5 times.

In an embodiment of the first or the second aspect (i.e., independently combinable with any of the aspects or embodiments identified herein), the two rollers have a nip of 0.007 inches to about 0.050 inches.

In an embodiment of the first or the second aspect (i.e., independently combinable with any of the aspects or embodiments identified herein), one of the two rollers rotates faster than the other.

In an embodiment of the first or the second aspect (i.e., independently combinable with any of the aspects or embodiments identified herein), one of the two rollers rotates faster than the other, optionally up to 1.15 times faster than the other.

In an embodiment of the first or the second aspect (i.e., independently combinable with any of the aspects or embodiments identified herein), one of the two rollers has a variable speed of from 5 to 150 rpm.

In an embodiment of the first or the second aspect (i.e., independently combinable with any of the aspects or embodiments identified herein), the two rollers have a variable speed of from 5 to 150 rpm.

In an embodiment of the first or the second aspect (i.e., independently combinable with any of the aspects or embodiments identified herein), pressure is applied in a series of pulses, wherein a temperature of the mixture rises to over 200° C. at a peak pressure in a pulse and then subsides until a next pulse.

In an embodiment of the first or the second aspect (i.e., independently combinable with any of the aspects or embodiments identified herein), the pressure is from 100-400 megapascals.

In an embodiment of the first or the second aspect (i.e., independently combinable with any of the aspects or embodiments identified herein), the mixture further comprises one or more of a virgin rubber or a virgin elastomer or a synthetic rubber.

In an embodiment of the first or the second aspect (i.e., independently combinable with any of the aspects or embodiments identified herein), the mixture is processed in a continuous three-step process comprising: dry coating ground tire rubber particles with at least one organometallic compound selected from copper sulfide, iron (II) acetate, and copper (II) acetate in a spray-mixing auger/pugmill to obtain dry-coated ground tire rubber particles; feeding the dry-coated ground tire rubber particles through a co-rotating lobed bar compression gauntlet to obtain processed particles; and squeezing processed particles with a screw through a high shear knife-die assembly, whereby a rubber-based elastomer comprising 50-75 micron sized rubber particles is obtained.

In an embodiment of the first or the second aspect (i.e., independently combinable with any of the aspects or embodiments identified herein), the mixture is processed using a single screw extruder, armed with one or more tiny orifice breaker plates, and run at pressures of from 400-600 bars, whereby a rubber-based elastomer comprising approximately 10 micron sized rubber particles is obtained.

In an embodiment of the first or the second aspect (i.e., independently combinable with any of the aspects or embodiments identified herein), the mixture is processed in a continuous three-step process comprising: dry coating ground tire rubber particles with at least one organometallic compound selected from copper sulfide, iron (II) acetate, and copper (II) acetate in a spray-mixing auger/pugmill to obtain dry-coated ground tire rubber particles; feeding the dry-coated ground tire rubber particles through a co-rotating lobed bar compression gauntlet to obtain processed particles; and squeezing processed particles with a screw through a high shear knife-die assembly, whereby a rubber-based elastomer comprising 50-75 micron sized rubber particles is obtained.

In an embodiment of the first or the second aspect (i.e., independently combinable with any of the aspects or embodiments identified herein), the mixture is processed in a continuous three-step process comprising: Combining ground tire rubber particles with water and at least one organometallic compound selected from copper sulfide, iron (II) acetate, and copper (II) acetate in a spray-mixing auger/pugmill to obtain a mixture; feeding the mixture through a co-rotating lobed bar compression gauntlet to obtain processed rubber; and squeezing the processed rubber with an auger through a high shear knife-die assembly, whereby a rubber-based elastomer comprising <1 micron sized rubber particles is obtained.

In an embodiment of the first or the second aspect (i.e., independently combinable with any of the aspects or embodiments identified herein), the mixture comprises 1-10% by weight water.

In an embodiment of the first or the second aspect (i.e., independently combinable with any of the aspects or embodiments identified herein), the mixture comprises 5% by weight water.

In an embodiment of the first or the second aspect (i.e., independently combinable with any of the aspects or embodiments identified herein), a controlled but moving pack-seal composed of the processed rubber is formed between an end of the auger and a backside of the knife attached to the auger, which impinges the processed rubber into a twisting, high viscosity flow propelled between the mechanical ramming forces generated by material from the auger, whereupon the temperature rises from near ambient to 300° F. or higher.

In an embodiment of the first or the second aspect (i.e., independently combinable with any of the aspects or embodiments identified herein), an impingement zone formed between an end of the auger and a backside of the knife attached to the auger functions as a hydro-cracking retort that fractures the processed rubber into the rubber-based elastomer comprising <1 micron sized rubber particles.

In an embodiment of the first or the second aspect (i.e., independently combinable with any of the aspects or embodiments identified herein), the method further comprises finishing the rubber-based elastomer comprising <1 micron sized rubber particles through calendar rolls into a film composed substantially of <1 micron sized rubber particles.

In a generally applicable third aspect (i.e., independently combinable with any of the aspects or embodiments identified herein), an elastomer is provided prepared by the method of any of the first or second aspects or embodiments thereof.

In an embodiment of the third aspect (i.e., independently combinable with any of the aspects or embodiments identified herein), the elastomer is subjected to cross-linking.

In an embodiment of the third aspect (i.e., independently combinable with any of the aspects or embodiments identified herein), the elastomer is fabricated into a rubber-containing article.

In an embodiment of the third aspect (i.e., independently combinable with any of the aspects or embodiments identified herein), the rubber-containing article is a new tire.

In an embodiment of the third aspect (i.e., independently combinable with any of the aspects or embodiments identified herein), the rubber-containing article is an engineered rubber article.

In a generally applicable fourth aspect (i.e., independently combinable with any of the aspects or embodiments identified herein), a method is provided for preparing a rubber-based elastomer, comprising: applying pressure to a mixture comprising sulfur-crosslinked rubber particles and iron (II) acetate, then releasing the pressure, whereby a rubber-based elastomer is obtained.

In an embodiment of the fourth aspect (i.e., independently combinable with any of the aspects or embodiments identified herein), the iron (II) acetate is present in the mixture at from 1 to 5% by weight of the mixture.

In an embodiment of the fourth aspect (i.e., independently combinable with any of the aspects or embodiments identified herein), the iron (II) acetate is present in the mixture at about 2% by weight of the mixture.

In an embodiment of the fourth aspect (i.e., independently combinable with any of the aspects or embodiments identified herein), the iron (II) acetate is present in the mixture at from about 1-1.5% by weight of the mixture.

In an embodiment of the fourth aspect (i.e., independently combinable with any of the aspects or embodiments identified herein), the iron (II) acetate is provided in an aqueous solution.

In an embodiment of the fourth aspect (i.e., independently combinable with any of the aspects or embodiments identified herein), the solution of iron (II) acetate in water is combined with the sulfur-crosslinked rubber particles and the pressure applied within 15 minutes of the iron (II) acetate being dissolved in water.

In an embodiment of the fourth aspect (i.e., independently combinable with any of the aspects or embodiments identified herein), the aqueous solution has a pH above 7.

In an embodiment of the fourth aspect (i.e., independently combinable with any of the aspects or embodiments identified herein), the aqueous solution has a pH of about 8.

In an embodiment of the fourth aspect (i.e., independently combinable with any of the aspects or embodiments identified herein), 2 parts by weight water is present to 1 part by weight sulfur-crosslinked rubber particles in the mixture.

In an embodiment of the fourth aspect (i.e., independently combinable with any of the aspects or embodiments identified herein), the rubber-based elastomer is combined with asphalt as an asphalt modifier.

In an embodiment of the fourth aspect (i.e., independently combinable with any of the aspects or embodiments identified herein), 1 part by weight water is present to 20 parts by weight sulfur-crosslinked rubber particles in the mixture.

In an embodiment of the fourth aspect (i.e., independently combinable with any of the aspects or embodiments identified herein), the mixture further comprises a virgin elastomer.

In an embodiment of the fourth aspect (i.e., independently combinable with any of the aspects or embodiments identified herein), the virgin elastomer comprises natural rubber, styrene-butadiene rubber, or a mixture thereof.

In an embodiment of the fourth aspect (i.e., independently combinable with any of the aspects or embodiments identified herein), the rubber-based elastomer is molded into a molded rubber product.

In an embodiment of the fourth aspect (i.e., independently combinable with any of the aspects or embodiments identified herein), the sulfur-crosslinked rubber particles are in a form of ground tire rubber having an average particle size of approx. 600 microns.

In an embodiment of the fourth aspect (i.e., independently combinable with any of the aspects or embodiments identified herein), the ground tire rubber is end-of-life tire rubber.

In an embodiment of the fourth aspect (i.e., independently combinable with any of the aspects or embodiments identified herein), the mixture further comprises a reducing agent.

In an embodiment of the fourth aspect (i.e., independently combinable with any of the aspects or embodiments identified herein), the reducing agent comprises ammonia.

In an embodiment of the fourth aspect (i.e., independently combinable with any of the aspects or embodiments identified herein), applying pressure occurs in a high shear mixer.

In an embodiment of the fourth aspect (i.e., independently combinable with any of the aspects or embodiments identified herein), the method further comprises preparing a mixture comprising the rubber-based elastomer and copper (II) acetate, applying pressure to the mixture of the rubber-based elastomer and copper (II) acetate, then releasing the pressure, whereby a reduced particle size rubber-based elastomer is obtained.

In an embodiment of the fourth aspect (i.e., independently combinable with any of the aspects or embodiments identified herein), the iron (II) acetate is present in the mixture comprising sulfur-crosslinked rubber particles and iron (II) acetate at about 1.5% by weight of the mixture, and wherein the copper (II) acetate is present in the mixture comprising rubber-based elastomer and copper (II) acetate at about 0.5% by weight of the mixture comprising rubber-based elastomer and copper (II) acetate.

In a generally applicable fifth aspect (i.e., independently combinable with any of the aspects or embodiments identified herein), a method is provided for preparing a rubber-based elastomer, comprising: applying pressure to a mixture comprising sulfur-crosslinked rubber particles and particles of a digenite lattice of copper sulfide, then releasing the pressure, whereby a resident sulfur in a rubber crosslink of the sulfur-crosslinked rubber particles is transferred to the digenite lattice of copper sulfide, whereby a rubber-based elastomer is obtained.

In an embodiment of the fifth aspect (i.e., independently combinable with any of the aspects or embodiments identified herein), the particles of the digenite lattice of copper sulfide are provided in a carrier comprising oleic acid ligand, and wherein the oleic acid ligand reduces the resident sulfur in the rubber crosslink prior to its transfer to the digenite lattice of copper sulfide.

In an embodiment of the fifth aspect (i.e., independently combinable with any of the aspects or embodiments identified herein), the oleic acid ligand is provided in a form of soy oil containing 22% by weight oleic acid component.

In an embodiment of the fifth aspect (i.e., independently combinable with any of the aspects or embodiments identified herein), the particles of the digenite lattice of copper sulfide and the carrier are mixed at a weight ratio of 1:4 prior to mixing with the sulfur-crosslinked rubber particles.

In an embodiment of the fifth aspect (i.e., independently combinable with any of the aspects or embodiments identified herein), the particles of the digenite lattice of copper sulfide are provided in a mixture with a stabilizer, optionally silica particles.

In an embodiment of the fifth aspect (i.e., independently combinable with any of the aspects or embodiments identified herein), the silica particles are nanoparticles of approx. 160 m²/g surface area.

In an embodiment of the fifth aspect (i.e., independently combinable with any of the aspects or embodiments identified herein), the particles of the digenite lattice of copper sulfide and the carrier are mixed at a weight ratio of 1:4 to yield a suspension, and wherein the suspension is combined with the stabilizer at a weight ratio of 1:5 to yield a mixture.

In an embodiment of the fifth aspect (i.e., independently combinable with any of the aspects or embodiments identified herein), the mixture of the suspension and the stabilizer is combined with sulfur-crosslinked rubber particles in a weight ratio of 4:96.

In an embodiment of the fifth aspect (i.e., independently combinable with any of the aspects or embodiments identified herein), the sulfur-crosslinked rubber particles are in a form of ground tire rubber having an average particle size of approx. 600 microns.

In an embodiment of the fifth aspect (i.e., independently combinable with any of the aspects or embodiments identified herein), the ground tire rubber is end-of-life tire rubber.

In an embodiment of the fifth aspect (i.e., independently combinable with any of the aspects or embodiments identified herein), the particles of digenite lattice of copper sulfide are prepared by reacting metallic copper with sulfur at a temperature of 155° C. in a closed, vented ceramic vessel, and capturing escaping copper sulfide in an activated carbon filter, optionally subjecting the copper sulfide to hydro-quenching to achieve a particle size of <100 nm.

In an embodiment of the fifth aspect (i.e., independently combinable with any of the aspects or embodiments identified herein), the copper is 99% by weight pure copper metal in a form of wire or particles and wherein the sulfur is in a form of 99% by weight pure precipitated sulfur.

In an embodiment of the fifth aspect (i.e., independently combinable with any of the aspects or embodiments identified herein), the digenite lattice of copper sulfide is converted to a covellite phase of copper sulfide.

In a generally applicable sixth aspect (i.e., independently combinable with any of the aspects or embodiments identified herein), a method is provided for preparing a rubber-based elastomer, comprising: applying pressure to a mixture comprising sulfur-crosslinked rubber particles and an alkaline earth metal acetate, then releasing the pressure, whereby a rubber-based elastomer is obtained.

In an embodiment of the sixth aspect (i.e., independently combinable with any of the aspects or embodiments identified herein), the alkaline earth metal acetate is magnesium acetate.

In an embodiment of the sixth aspect (i.e., independently combinable with any of the aspects or embodiments identified herein), the alkaline earth metal acetate is calcium acetate.

In a generally applicable seventh aspect (i.e., independently combinable with any of the aspects or embodiments identified herein), an elastomer is provided prepared by a method of the fourth aspect or any embodiment thereof.

In an embodiment of the seventh aspect (i.e., independently combinable with any of the aspects or embodiments identified herein), the elastomer is subjected to cross-linking.

In an embodiment of the seventh aspect (i.e., independently combinable with any of the aspects or embodiments identified herein), the elastomer is fabricated into a rubber-containing article.

In an embodiment of the seventh aspect (i.e., independently combinable with any of the aspects or embodiments identified herein), the rubber-containing article is a new tire.

In an embodiment of the seventh aspect (i.e., independently combinable with any of the aspects or embodiments identified herein), the rubber-containing article is an engineered rubber article.

Any embodiment of any aspect may be combined, in whole or in part, with any other embodiment of any other aspect(s) or embodiment(s). Likewise, any feature of an embodiment or aspect may be combined, in whole or in part, with any other embodiment(s) or aspect(s).

### DESCRIPTION OF THE DRAWINGS

FIG. 1A provides a top view and end view of an embodiment of a horizontal compression reactor.

FIG. 1B provides an exploded view of the horizontal compression reactor of FIG. 1A.

FIG. 1C provides a top view of the horizontal compression reactor of FIG. 1A.

FIG. 1D provides an end view of the horizontal compression reactor of FIG. 1A.

FIG. 2 provides schematics of the process of compressing rubber crumb precoated with reactant in a horizontal compression reactor.

FIGS. 3A-3C provide views of an embodiment of a micro-compounding reactor incorporating twin counter rotating screws. FIG. 3A provides a view of the barrel, FIG. 3B provides a view of the end plate, and FIG. 3C provides a view of one of the rotating screws.

FIGS. 4A and 4B depict views of an interfusion reactor 1700 incorporating a shaft collar 1701, four thrust bearings 1702, a ½ inch shaft 1703, an oilite bearing 1704, a ½ inch stainless steel (ss) housing lid 1705, a shaft collar 1706, a ⅜ inch stainless steel rotor 1707, shims 1708 (as needed), a ⅜ inch stainless steel spacer 1709, a ⅜ inch stainless steel stator 1710, an oilite bushing 1711, and a ½ inch bushing plate 1712.

FIG. 5A depicts a standard mixing lobe design including a first lobe 5001 with side view 5003, and a second lobe 5002.

FIG. 5B depicts a modified lobe design and a modified barrel design. The design includes a first lobe 5001 and a second lobe 5002. The barrel (jacketed barrel 5011) is a two piece clamshell barrel 5005. Three alternative Stress-Strain Lug (SSL) designs 5006 are depicted. Piezoelectric transducer driven acoustic horns 5007 are provided, which are associated with an area of quantum field activity 5008. The gap 5009 between paired lobes is 0.015″ and the gap 5010 between a lobe and the barrel is 0.050″.

FIG. 5C is a photograph showing details of the paired lobes of the CPE.

FIG. 5D is a photograph of the CPE with half of the clamshell barrel removed, exposing the interior and showing the arrangement of lobes and rotating screws.

FIG. 5E depicts a modified lobe design and a modified barrel design similar to that depicted in FIG. 5B, showing the engagement of the lobes 5001 and 5002. The design includes an upper one-half reactor tunnel 5020, a lower one-half reactor tunnel 5021, ultrasonic transducers 5022, and alternating ports (not depicted) at upper and lower work positions for liquid nitrogen injection. The liquid nitrogen mitigates, by cold temperature embrittlement, the otherwise flexible ground tire rubber particle. This achieves quicker and more complete size reduction when coordinated with the ultrasonic transducer pulses from the piezoelectric transducer driven acoustic horns.

### DETAILED DESCRIPTION OF THE EMBODIMENTS

The following description and examples illustrate an embodiment of the present invention in detail. Those of skill in the art will recognize that there are numerous variations and modifications of this invention that are encompassed by its scope. Accordingly, the description of an embodiment should not be deemed to limit the scope of the present invention. Introduction

An ambient, end of life (EOL), ground tire rubber (GTR) particle in the size range of approx. 600 microns (30 mesh), also referred to as a ground scrap tire moiety (GSTM), has a cross section composed of either the old tire tread or the tire side wall or a combination of the two. It may be generally characterized as a heterogeneous matrix of an interpenetrating, cross linked, elastomer network filled with inorganic substances, primarily carbon. Depending upon whether it is primarily tire tread or sidewall in origin the primary entangled elastomers will be natural rubber (NR) or styrene butadiene/butadiene rubber (BR S-BR), with the BR and S-BR typically having the larger mass component in the tread for better wear and the sidewall having an NR bias for improved flexural qualities. The crosslink may generally be described as elemental sulfur and/or a complex compound incorporating sulfur as its principal element, e.g., a polysulfidic chemical.

During tire construction the interpenetrating elastomer networks are formed using a sequential crosslink of the predominant elastomer (NR or S-BR) followed by the crosslink of the secondary elastomer, such that the secondary elastomer is “bent” to conform to the already vulcanized, higher strength primary elastomer. This technique imparts mechanical characteristics that are retained in the individual GTR particle.

A single vehicle tire, after being stripped of steel and fiber reinforcement will yield approximately sixteen pounds (16 lbs.) of reusable GTR, with truck tires yielding more. Over one billion EOL tires are generated worldwide annually. About 50% are consumed as low value fuel. Where possible, maximizing the reuse of this raw material for its proven mechanical properties represents a substantial challenge, but to the extent achieved, a resource recovery value of as much as 200:1 is observed when comparing its possible re-use in new tire construction to being consumed in a furnace for its BTU content.

Notably, recent detailed studies of the environmental advantages such a reversal of EOL-GTR usage, maximized, predicts that atmospheric carbon contribution might be reduced by the equivalent of shutting down 14 coal fired power plants (300,000 rail cars of coal) or removing six million vehicles from the roads or planting an additional 62 million acres of forests (equivalent to an area the size of the state of Arizona) for carbon sequestration. Accordingly, one object of the methods and compositions discussed herein is to prepare the GTR particle so that it may be integrated into the full spectrum of industrial rubber goods manufactured worldwide.

Unassisted, elemental sulfur will slowly crosslink functional rubber polymers, but the process is too slow and has too many end property difficulties to be a commercially realistic alternative to a commercially successful vulcanization. Vulcanization as discussed herein regards an accelerated sulfur vulcanization process as is practiced in commercial vulcanization.

Sulfur vulcanization was discovered by Charles Goodyear in 1839. After 178 years of development, it is universally agreed that the processes are complex which result in the formation of the transverse sulfuric bridge between adjacent, interpenetrating rubber polymers. These bridges in turn yield mechanical properties in an elastomeric material which are critical to civilization. However, much progress has been made and many, definitive elements of the progression are well established.

While a free-radical mechanism had long been assumed to be the controlling phenomena, more recently, with the advent of more advanced methods of discreet process characterization, a convincing presence has not been detected of the primary, theoretical radicals necessary to validate that mechanism. In contrast, an ionic mechanism has been predicted and validated using similar advanced process characterization methods. Since the modern vulcanization process involves many chemical components being mixed together at the start of the process, each (combination) with its own chemical reaction pathway, it is likely that both radical and ionic mechanisms are active but analysis reveals that the ionic mechanism is predominant.

A typical example (by wt. %) of an NR-BR tire compound is: NR 80%, BR 20%, ZnO 5%, steric acid 2%, silica-talc 3%, carbon black 55%, aromatic oil 10%, elemental sulfur 1.7%, N-Cyclohexyl-2-benzothiazole sulfenamide (CBS—an accelerator) 1.2%, 2-(4-Morpholinothio)-benzothiazole (MBS—an accelerator) 1.1%, and N-tert-butyl-2-benzothiazole sulfenamide (TBBS—an accelerator) 1.1%.

The process begins in a heated mold, after the tire recipe components have been thoroughly distributed and dispersed. The vulcanization process may be seen in three sequential events: 1) formation of the accelerator complex chemistry, 2) formation of the cros slink precursor, and 3) completion of the cros slink.

### Conventional Usage of Scrap Rubber in Tire

Excluding the rubber trimmings generated prior to the final heating and cross linking of new tires, it is estimated that less than 0.004% by weight of all EOL tires are reincorporated into a new tire master batch. Such reincorporation has been successfully accomplished at master batch loadings for passenger car tires of up to 3% by weight utilizing very fine, cryogenically processed ground rubber obtained from EOL tires. A loading of EOL tire-derived processed ground rubber greater than this has thus far not been feasible, in that the physical properties required of new tire applications are not met at higher loading levels. Tire production typically begins with a base formula of components, with the base formula developed by selection of raw material(s). This is then reduced to a master batch in high shear mixing equipment. Typically, the master batch is done in two phases: the master pass and the finish pass. The master pass combines various rubber species which are introduced as small bales or sheets and are blended with fine powders of carbon black and minerals, as well as a small quantity of process oil(s). This step is performed at the high temperature required to lower the viscosity of the rubber elements such that the flow-resistant powder elements can be uniformly distributed in sufficiently small clusters or packets. These clusters or packets can then be subsequently dispersed to a minimal particle size. The finish pass is done at a lower temperature and usually under process conditions that create more of a smearing action of the heterogeneous elements. In the finish pass, rubber polymers are not further degraded by high temperatures as in the master pass, and the uniformly distributed agglomerates of powder components are worked into such small physical size that they become dispersed within the free molecular space of the rubber elements. Once the finish pass is completed, the master batch bales are ejected from the mixer and rolled into thin sheets (referred to as milling). The milled sheets are used to lay up, on specialized forming equipment, the tire carcass prior to being placed in a compression molding press for final crosslinking by thermal and/or chemical means.

Crosslinking accelerants include mercapto group or sulfur-based (e.g., elemental sulfur and/or, accelerator derivatives of N-tert-butyl-2-benzothizolesulfenamide (TBBS)). The sulfur-based crosslinking agents which react with sites in the master batch at or above a prescribed temperature may be partially introduced at both the master pass and the finish pass phase. The crosslinking during the final heating of the tire carcass causes the reactive sites in the various rubber elements to build a sufficient crosslink density to achieve the final physical properties required to meet the sustained load and heat environment to which the tire will be subjected.

Rubber from End-of-Life Tire Scrap

Rubber-containing crumb is manufactured from two primary feedstocks: tire buffings, a byproduct of tire retreading, whole tire, and scrap tire rubber. Scrap tire rubber comes from three types of tires: passenger car tires; truck tires; and off-the-road tires. End product yields for each of these tire types are affected by the tire's construction, strength, and weight. On average, 10 to 16 pounds of end-of-life tire crumb can be derived from one passenger tire. Other sources of rubber-containing crumb include products containing or made using recycled rubber-containing crumb, e.g., new rubber products, playground surfacing, rubber mulch, drainage aggregate, construction fill material, scraps from manufacturing, and the like.

Tires are composite structures containing a number of components. The tire carcass is composed of the tread, bead, sidewall, shoulder, and ply. Tires are formed from components such as natural and/or synthetic rubber, cords, and filler. The polymer most commonly employed for the tread and encasement of the cords is a blend of NR and S-BR copolymer. Cords form the ply and bead of the tire, and provide tensile strength necessary to contain the inflation pressure. Cords can comprise steel, natural fibers such as cotton or silk, and synthetic fibers such as nylon or Kevlar. Fillers can include silica and carbon black. A representative tire can comprise one or more of: synthetic rubber, natural rubber, sulfur and sulfur-containing compounds, silica, phenolic resin, oil (aromatic, naphthenic, and/or paraffinic), fabric (polyester, nylon, etc.), petroleum waxes, pigments (zinc oxide, titanium dioxide, etc.), carbon black, fatty acids, miscellaneous inert materials, and steel wire.

The typical passenger tire comprises 14% natural rubber, 27% synthetic rubber, 28% carbon black, 14-15% steel, and 16-17% fabric, fillers, accelerators, antiozonants, and other miscellaneous components. The average weight of a new passenger car tire is 25 lbs., and for a scrap passenger tire 22 lbs. Truck tires typically contain 27% natural rubber, 14% synthetic rubber, 28% carbon black, 14-15% steel, and 16-17% fabric, fillers, accelerators, antiozonants, and other miscellaneous components. The average weight of a new truck tire is 120 lbs., and for a scrap truck tire 110 lbs. Other types of tires can contain higher amounts of synthetic and/or natural rubber, e.g., 70% (by weight) rubber, 15% steel, 3% fiber, and 12% of other materials such as inert fillers. Rubber is found in tire components including tread, innerliner, beads, belts, and the like. The percent rubber by weight in a new passenger tire is typically as follows: 32.6% in tread; 1.7% in base, 21.9% in sidewall, 5.0% in bead apex, 1.2% in bead insulation, 11.8% in fabric insulation; 9.5% in insulation of steel cord, 12.4% in innerliner, and 3.9% in undercushion.

The rubber compounds employed in a typical tire, along with associated materials, are set forth in Table 1. The methods described herein are suitable for processing tire tread, base, sidewall, as well as innerliner, and are also suitable for processing other materials containing vulcanized (or otherwise cross linked) natural rubber, styrene-butadiene rubber, and isobutylene-isoprene rubber. As further described herein, the other components, e.g., carbon black, present in EOL tire or other vulcanized-rubber containing articles of manufacture may in some embodiments remain in the rubber subjected to the processes described herein, with no processing conducted to impact the properties or amounts of the other component(s). In other embodiments, the rubber may be subjected to further processes to enrich or minimize these additional components, or change their properties.

TABLE 1

| | Tread | Base | Sidewall | Innerliner |
|---|---|---|---|---|
| | (PHR) | (PHR) | (PHR) | (PHR) |
| Natural Rubber | 50.0 | 100.0 | 75.0 | |
| Styrene-Butadiene Rubber | 50.0 | | 25.0 | |
| Isobutylene-Isoprene Rubber | | | | 100.0 |
| Carbon Black (Grade N110) | 50.0 | 15.0 | 20.0 | |
| Carbon Black (Grade N330) | | 25.0 | 35.0 | |
| Carbon Black (Grade N765) | | | | 50.0 |
| Processing Oil | 7.5 | 5.0 | 5.0 | 3.0 |
| Antioxidant | 1.0 | 0.75 | 1.0 | 1.0 |
| Antioxidant Wax | | | 2.0 | |
| Stearic Acid | 2.0 | 4.0 | 3.0 | 1.5 |
| Zinc Oxidant | 5.0 | 5.0 | 5.0 | 5.0 |
| Accelerator (High) | | 1.0 | 0.7 | |
| Accelerator (Middle) | 1.25 | | | 0.4 |
| Accelerator (Low) | | | | 0.4 |
| Sulfur | 2.5 | 3.0 | 2.8 | 2.0 |

*PHR = Per Hundred Rubber, parts on a weight basis
*Carbon grade = ASTM grading: Particle size and structure of carbon are different.

There are approximately 2.5 pounds of steel belts and bead wire in a passenger car tire. This material is made from high carbon steel with a nominal tensile strength of 2750 MN/m². The steel tire cord composition of a typical tire is set forth in Table 2.

TABLE 2

| | |
|---|---|
| Steel Belts | Bead Wire |

| | | | |
|---|---|---|---|
| Carbon | 0.67-0.73% | 0.60% | min. |

| | | |
|---|---|---|
| Manganese | 0.40-0.70% | 0.40-0.70% |
| Silicon | 0.15-0.03% | 0.15-0.30% |

| | | | | |
|---|---|---|---|---|
| Phosphorus | 0.03% | max. | 0.04% | max. |
| Sulfur | 0.03% | max. | 0.04% | max. |

| | | |
|---|---|---|
| Copper | Trace | Trace |
| Chromium | Trace | Trace |
| Nickel | Trace | Trace |

| | | | | |
|---|---|---|---|---|
| Coating | 66% | Copper | 98% | Brass |
| | 34% | Zinc | 2% | Tin |

Whole tires can be ground to yield rubber particles mixed with other components of the tire. Methods for producing rubber containing particles from tires are known in the art. The used tires (or shreds or granules thereof) can be subjected to an optional cleaning step (e.g., a water wash). Tires can be recycled by subjecting them to an initial shredding step, then subjecting the shreds to a granulation process to yield an initial granulate having dimensions of 1-3 cm. Grinding can be conducted under ambient conditions (e.g., in a granulator or a cracker mill) or cryogenic conditions.

Ambient grinding is a multi-step processing technology that uses a series of machines (usually three) to separate the rubber, metal, and fabric components of the tire. Whether using granulation equipment or cracker mills, the first processing step typically reduces the original feedstock to small chips. The second machine in the series will grind the chips to separate the rubber from the metal and fabric. Then a finishing mill will grind the material to the required product specification. After each processing step, the material is classified by sifting screens that return oversize pieces to the granulator or mill for further processing. Magnets are used throughout the processing stages to remove wire and other metal contaminants.

In the final stage, fabric is removed by air separators. Rubber particles produced in the granulation process generally have a cut surface shape and rough texture, with similar dimensions on the cut edges.

Cracker mills use two large rotating rollers with serrations cut in one or both of them. The roll configurations are what make them different. These rollers operate face-to-face in close tolerance at different speeds. Product size is controlled by the clearance between the rollers. Cracker mills are low speed machines operating at about 30-50 RPM. The rubber usually passes through two to three mills to achieve various particle size reductions and further liberate the steel and fiber components. These mills do not have screens built into the mill and as such the mill itself does not control the final particle. A stand-alone screening system will separate “sized” particles from oversize granules following the mill and re-circulate the oversize products. The particles produced by the cracker mill are typically long and narrow in shape and have a high surface area.

Cryogenic processing uses liquid nitrogen or other materials/methods to freeze tire chips or rubber particles prior to size reduction. Most rubber becomes embrittled or “glass-like” at temperatures below −80° C. The use of cryogenic temperatures can be applied at any stage of size reduction of scrap tires. Typically, the size of the feed material is a nominal 2 inch chip or smaller. The material can be cooled in a tunnel style chamber, immersed in a “bath” of liquid nitrogen, or sprayed with liquid nitrogen to reduce the temperature of the rubber or tire chip. The cooled rubber is size-reduced in an impact type reduction unit, centrifuge, or hammer mill. This process reduces the rubber to particles ranging from ¼ inch minus to 30 mesh, with the majority of the particle distribution between ¼ inch minus and 20 mesh. A typical throughput is 4,000 to 6,000 pounds per hour. Cryogenic grinding avoids heat degradation of the rubber and produces a high yield of product that is free of almost all fiber or steel, which is liberated during the process.

Wet grinding is a processing technology used to manufacture particles that are 40 mesh and finer. The wet grind process mixes partially refined crumb rubber particles with water creating a slurry. This slurry is then conveyed through size reduction and classification equipment. When the desired size is achieved, the slurry is conveyed to equipment for removing the majority of the water and then drying. Aside from the use of water, the same basic principles that are used in an ambient process are utilized in a wet grinding process. The major advantage for a wet grind process is the ability to create fine mesh crumb rubber. While products as coarse as 40 mesh are produced, the majority of the particles are 60 mesh and finer. A percentage of the overall throughput is finer than 200 mesh. Another advantage for a wet grind process is the cleanliness and consistency of the crumb rubber produced. The process washes the crumb rubber particles. The wet process removes the fine particles of fiber from the crumb rubber making a very clean product.

The initial granulate contains steel, rubber, and textile components. The steel is typically recovered using a multistage magnetic separation process to minimize the loss of rubber. This can entail a first step utilizing a high strength twin pole overband cross belt separator magnet to remove metal containing particles in a first step. The second step involves a magnetic drum separator or magnetic pulley utilizing high strength rare earth magnets. The axial magnetic field causes the metal containing particles to tumble and release entrapped rubber. For fine rubber material that is fed into a powder grinder, a plate magnet suspended close to the product over the conveyor can lift and remove fine wire fragments. Testing can be conducted to determine metal content, e.g., by using a magnetometer.

The fiber can be recovered using modified gin machinery as known in the textile industry. A two-step process is typically employed, where clean fiber is removed from EOL tire crumb using a modified gin cylinder cleaner (used in the textile industry to remove foreign matter from seed cotton). Partially cleaned crumb is subjected to a second step to remove fiber, which can still contain some rubber particles. The resulting cleaned EOL tire crumb is then collected for packaging or other use. See, e.g., W. Stanley Anthony, Applied Engineering in Agriculture, Vol. 22(4): 563-570.

American Society for Testing and Materials (ASTM) has standards for specifying different size ranges of crumb rubber, such as 30 mesh or 80 mesh. The range of particle sizes can be determined by sieve analysis, consisting of shaking and tapping a measured quantity of a crumb rubber sample through a specified number of test sieves over a specified time. The amount of sample retained on each screen is weighed and results are given as the percentage of sample retained on each screen. The recommended procedure for sieve analysis using the Rotap method is provided in ASTM 5644. Typical crumb rubber sizes directed to certain products and uses include the following: molded and extruded products, 4-100 mesh; asphalt modification, 16-40 mesh; sport surfacing, ¼″-40 mesh; automotive products, 10-40 mesh; tires, 80-100 mesh; rubber and plastic blends, 10-40 mesh; and construction, 10-40 mesh.

There are no unified U.S. standards for processing EOL tire rubber crumb; however, a suitable EOL tire rubber crumb for use in interlinked substitution typically has a low fiber content (less than 0.02% of total weight), low metal content (less than 0.01% of total weight), high consistency, and the particles are preferably sized for 100% pass through 16 mesh. In some embodiments, it may be acceptable to have particles of larger size, e.g., 14, 12, or even 10 mesh. For example, 10-40 mesh crumb rubber (e.g., 30 mesh, or 25-35 mesh) yields satisfactory results when processed according to the methods described herein. Smaller particles, e.g., 41-200 mesh, can be employed and may enable more efficient interlinked substitution; however, a reduction in particle size will incur greater expense in manufacture of the crumb of the specified size. Larger particles, e.g., less than 10 mesh (4-9 mesh) can also be subjected to the methods, e.g., for particle size reduction purposes.

ASTM D5603 Standard Classification for Rubber Compounding Materials—Recycled Vulcanizate Particulate, classifies vulcanized particulate rubber according to maximum particle size, size distribution and parent materials including whole tires, tire peels, buffings generated from the tire tread and shoulder, buffings generated from tire tread, shoulder and sidewall and non-tire rubber.

End-of-Life Tire Crumb Characterization ELT crumb containing vulcanized rubber and having the desired particle sizes can be manufactured or obtained from any suitable commercial source.

The ELT crumb is typically of such a size that 100% can pass through a 16 mesh screen, and may have a narrow size distribution (e.g., no smaller than 20 mesh and no larger than 16 mesh) or may have a broader size distribution (e.g., significant contents of fines and various other particle sizes less than 16 mesh). The crumb rubber is typically cleaned of fiber and wire to a purity of 99.5 wt. % (i.e., 0.5 wt. % or less of fiber and wire).

If the sulfur content of the ELT crumb is unknown, representative samples of the ELT crumb can be tested to determine sulfur content (typically measured in parts per hundred weight), such that a controlled amount of reactant can be used in the extraction process, thereby avoiding overutilization or underutilization of reactant. A stoichiometric amount of reactant to sulfur is typically employed; however, larger or smaller amounts can also be advantageously employed. Any suitable method can be employed to determine the sulfur compound; however, a nitric compound extraction process can be advantageously employed. ASTM D4578 describes standard test methods to apply to rubber chemicals for determination of percent sulfur. These test methods cover the determination of solvent insoluble materials in a sulfur-containing sample. The two test methods are: (1) Test Method A, Extraction by Carbon Disulfide, and (2) Test Method B, Extraction by Toluene. If there are no other solvent insoluble materials present in the sulfur-containing sample, the test methods determine the insoluble sulfur content directly. If other materials are also present, additional testing is necessary to identify what portion of the insolubles (e.g., carbon black, silica, or other inert fillers) is insoluble sulfur.

### Sulfur Crosslinking of Rubber

Elemental sulfur has cyclic eight atoms molecules at room temperature. In the presence of accelerators and activators, elemental sulfur generates sulfur fragments that react with reactive groups of rubbers in the process of interlinked substitution to create cross-links such as:

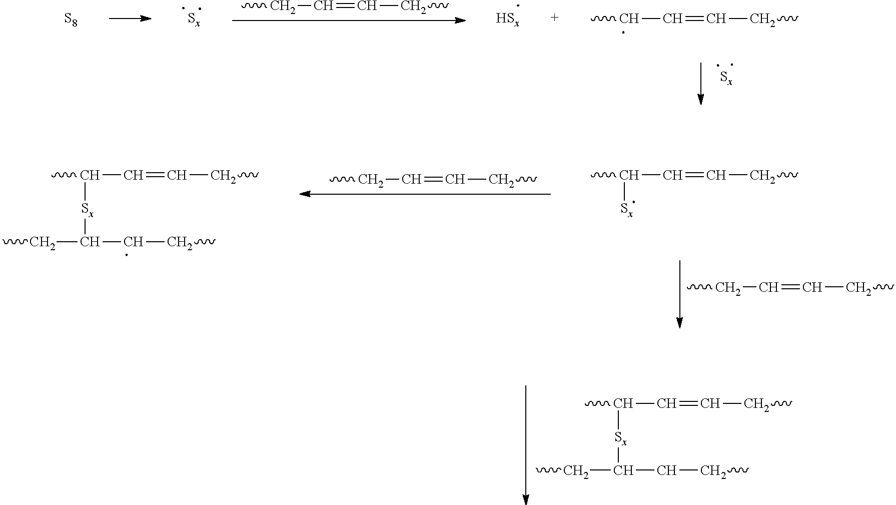

### Organometallic Reactants

Copper Sulfide

Copper sulfide is recognized as a versatile, molecular compound exhibiting low-to-no toxicity and is easily manufactured as a basic molecule with readily available and cost effective materials. Currently, copper sulfide exists in eight identified structures, from copper rich (Cu₂S) to sulfur rich (CuS). The eight forms are: 1) chalcocite (Cu₂S), 2) djurleite (Cu_{1.97}S), 3) digenite (Cu_{1.80}S), 4) anilite (Cu_{1.75}S), 5) geerite (Cu_{1.60}S), 6) spionkopite (Cu_{1.40}S), 7) yarrowite (Cu_{1.12}S) and 8) covellite (Cu_{1.00}S).

Based upon the sulfur packing into the lattice, these eight identified structures have been categorized into three different basic structures: Group I. cubic close packing (digenite, anilite), Group II. hexagonal close packing (chalcocite, djurleite) and Group III. combination of hexagonal close packing and covalent bonding of sulfur atoms (covellite). The structures of geerite, spionkopite, and yarrowite have not yet been fully characterized.

A variety of processing options have evolved, as is revealed in substantial literature on the subject of copper sulfide nano-compounding. Some examples include processing options centering on rate of development of the copper and sulfur lattice, microwave irradiation, hydro-thermal/salvo-thermal development, quenching methods, solvent pre-dispersement of components, pressurization, atmosphere, use of capping agents, and monitoring of process progression by methods such as impedance spectroscopy.

The manipulation of processing options for these eight stoichiometric phases can achieve different shapes of nanoparticles, including platelets, hollow spheres, rods, wires, tubes and sheets. The combination of lattice holes, dopants and shapes provides promising applications for copper sulfide derivatives, e.g., photocatalysts, sensors, batteries, opto-electric devices, and nano-structures in bio-medical applications.

For purposes of treatment of vulcanized rubber, the digenite form of copper sulfide can advantageously be employed; however, it is noted that the other forms may also be suitable for use in this application.

A baseline copper sulfide digenite phase (Cu_{1.80}S) can be prepared as follows. This method is exemplary, as other methods for generating the copper sulfide digenite phase are known in the art and may advantageously be employed. Copper and sulfur in ambient atmosphere (e.g., the atmosphere of the Earth), are heated to 155° C. in a closed, vented ceramic vessel. Escaping gas is captured and reacted in an activated carbon filter. The copper source can be a metallic copper of suitable form, e.g., a form having high surface area such as a wire or powder, of pure copper. By pure, in relation to copper, sulfur or any other material disclosed herein, it is meant a material that does not contain any other substance which substantially impact the process of formation of the copper sulfide, or the subsequent reaction of the copper sulfide with the vulcanized rubber matrix. Copper as is conventionally available in a 99% pure form or greater is typically suitable for use; however, in certain embodiments lower purity forms may also be employed. The sulfur source is advantageously a solid sulfur form as is conventionally available, e.g., in powder, granule or other solid form. An example of a suitable sulfur form is 99% pure precipitated sulfur. The two components' initial weights are calculated such that the final weight of the reacted copper sulfide achieves the molar ratio required to achieve the digenite form having the Group I cubic close packing lattice structure.

After reaction of the copper and the sulfur to form copper sulfide, the reacted copper sulfide is hydro-quenched to achieve a <100 nm average particle size, e.g., 10 nm to 99 nm, or 20 nm to 90 nm. While a particles size of <100 nm is advantageously employed, in certain embodiments a particle size of 100 nm or greater can be employed, e.g., 100 nm to 1 mm, or 200 nm to 900 nm.

In certain embodiments, wherein a PTR product generated from EOL vulcanized tire using only non-hazardous substances is desired, it is desirable to employ copper sulfide (the copper being in the form of Cu⁺, Cu²⁺, or a fractional molarity). The copper sulfide, which is insoluble in water, can be dry mixed with the EOL vulcanized tire particles. Alternatively, the copper sulfide can be provided in a supported form or with an oil as a carrier, as described elsewhere herein. In certain embodiments where copper sulfide is employed, a water-surfactant mixture may advantageously optionally be added to promote hydro-cracking. The resulting product prepared using copper sulfide yields a product having a completely, non-hazardous substance profile; however, cost per ton of product may be higher by this method than methods employing another OMC, as described elsewhere herein.
Iron (II) Acetate and Other OMCs

Other suitable OMCs include alkaline earth metal compounds, e.g., magnesium acetate and calcium acetate, or transition metal compounds, e.g., transition metals such as copper, iron, zinc, nickel, cobalt, and manganese, e.g., nickel acetate and iron acetate, as discussed in detail below.

An iron-based reactant can also be employed as a reactive component to dislocate attachment points in the crumb rubber polymer. As an example, the iron based reactant can be provided in a form of an iron salt, e.g., as iron (II) acetate (referred to herein also as ferrous acetate or Fe⁺ acetate), or other iron carboxylate, e.g., iron (II) (substituted or unsubstituted C₁₋₁₈ carboxylate). Iron (II) acetate can be prepared by various synthetic routes. For example, iron powder reacts with acetic acid in electrolysis to give the ferrous acetate, with evolution of hydrogen gas. Iron (II) acetate can also be made from iron (II) carbonate. Iron(II) acetate is a coordination complex with formula Fe(O₂CCH₃)₂. It adopts a polymeric structure with octahedral Fe(II) centers interconnected by acetate ligands. A hydrated form be made by the reaction of ferrous oxide or ferrous hydroxide with acetic acid. Selected impurities can be removed from the ferrous acetate by use of a magnetic sparger in the manufacturing process. Sparging can be conducted using hydrogen gas, reducing the Fe(III) form to Fe(II), while the magnetic field can remove metallic iron (iron in unoxidized form).

The iron reactant (OMC) is typically employed at from 0.1 to 5.0 parts reactant per 100 parts by weight vulcanized rubber (by weight), optionally 1 parts by weight to 3 parts by weight of reactant to 100 parts by weight vulcanized rubber; however, higher or lower amounts may also be employed in certain embodiments, e.g., a mixture containing reactant, vulcanized rubber, and other components as described elsewhere herein may contain 1-1.5 weight percent OMC. While not wishing to be bound by any theory, it is believed that in the reaction, iron (II) acetate ion dissociative substitution occurs at the methyl carbocation. This disrupts the vulcanization precursor, and the insertion forms a new functional site at the elastomer pendent structure for subsequent sulfidic bridge realignment. In the process, O²⁻ is converted to CO₂ with a phase space particle charged carbon aggregate. Strong interactions between Fe²⁺ and S²⁻ form a precipitate, which liberates a rigid sulfidic bridge to a ‘tether’ state, bound only at the original allylic carbocation.

Various other metal ions are also suitable for use, including but not limited to transition metals such as Cu²⁺, Co²⁺ (ligand exchange rate for an H₂O metal coordination matrix of 3×10⁶), Cu²⁺ (ligand exchange rate for an H₂O metal coordination matrix of 5×10⁹), Ni²⁺ (ligand exchange rate for an H₂O metal coordination matrix of 3×10⁴), Zn²⁺ (ligand exchange rate for an H₂O metal coordination matrix of 2×10⁷), and Mn²⁺ (ligand exchange rate for an H₂O metal coordination matrix of 2×10⁷. The iron or other metal can be provided in ionic form with an organic anion, e.g., acetate or other substituted or unsubstituted C₁₋₁₈ carboxylate, e.g., Cu (II) acetate or other such form. The metal in ionic form with an organic anion is typically employed in amounts as described above for iron (II) acetate, e.g., at from 0.1 to 5.0 parts reactant per hundred parts vulcanized rubber (by weight), optionally 1 parts by weight to 3 parts by weight of reactant to vulcanized rubber; however, higher or lower amounts may also be employed in certain embodiments. Similarly, alkaline earth metals may also be suitable for use, such as Ca²⁺ and Mg²⁺, in carboxylate, e.g., acetate form.

Iron (II) acetate is generally suitable for use as an organometallic compound in the methods of the embodiment. However, in certain embodiments it may be advantageous to include additional reactants.

In certain embodiments, it can be desirable to employ a single OMC (reactant) in the manufacture of a PTR. For example, only copper sulfide may be used, or only copper (II) acetate may be used, or only iron (II) acetate may be used in the manufacturing process. In other embodiments, combinations of OMC may advantageously be employed. For example, a process may utilize an admixture of two or more kinds of OMC (reactant), e.g., a dry admixture of solid copper (II) acetate and solid iron (II) acetate, or an aqueous slurry or solution of both copper (II) acetate and iron (II) acetate. The two components can be in any desired ratio (by weight), e.g., 1 part copper acetate to 0.01-100 parts iron (II) acetate or any ratio in between.

In certain embodiments, it can be desirable to employ a multi-stage process, wherein different stages of the process employ different OMCs (reactants). For example, variations of iron (II) acetate and copper tied to a basic carboxylic acid (e.g., copper (II) acetate) dissociate during a scissoring metathesis at a methyl carbocation of a sulfidic-bridge anchor point within the original, EOL vulcanized tire.

One example of a two-step process which requires a total of 2 wt. % waterborne reactant (based upon mass of active ingredient in solution versus 98 wt. % dry weight of EOL tire) can be employed to obtain a higher production efficiency. In this two-step process, in a first reaction stage 1.5 wt. % iron(II) acetate in waterborne form (based upon mass of iron(II) acetate in solution versus 98.5 wt. % dry weight of EOL tire) reacts with EOL vulcanized tire to yield an intermediate product. In the second reaction stage, a 0.5 wt. % copper (II) acetate in waterborne form (based upon mass of copper (II) acetate in solution versus 99.5 wt. % dry weight of EOL tire) is reacted with the intermediate process. In the reaction process as the rubber moieties become smaller, it becomes more difficult to reach shear dominance in the described electro-mechanical methods. A first reaction stage can economically achieve an initial particle size reduction using the relatively inexpensive iron (II) acetate, and then smaller particle size can be obtained through further processing with the currently more expensive but more reactive copper (II) acetate.
Reaction with Vulcanized Rubber

The copper sulfide in digenite form, iron (II) acetate, copper (II) acetate, or other organometallic reactant can be employed directly for reaction with a vulcanized rubber matrix such as ground tire rubber (GTR), e.g., end-of-life (EOL) tire rubber. However, it can advantageously be provided with a process ligand (carrier—reducing agent). The carrier can advantageously be an oleaginous material, e.g., a mineral oil or a vegetable or animal oil or fat. Examples of vegetable or animal fats or oils include coconut oil, corn oil, cottonseed oil, olive oil, palm oil, peanut oil, rapeseed oil, canola oil, safflower oil, sesame oil, soybean oil, sunflower oil, castor oil, tallow oil, and the like. In one embodiment, the vegetable oil is soybean oil. Advantageously, a carrier having properties as a reducing agent can be employed. One such form is that of an unsaturated fatty acid or fatty acid ester. Any suitable unsaturated fatty acid or fatty acid ester may be used, e.g., a C6-30 carboxylic acid or ester thereof. Depending upon the chain length, such fatty acids or fatty acid esters can contain 1 or more double bonds, e.g., 1, 2, 3, 4, or 5 or more double bonds. Fatty acids and fatty acid esters include, but are not limited to, linear and branched carboxylic acids, and can include fatty acids or olefins from the stearoyl family such as arachidonic acid, eicosapentaenoic acid, linoleic acid, alpha linolenic acid, gamma linolenic acid, oleic acid, palmitoleic acid, and combinations thereof. Other reducing agents can also be employed, if desired, however, a substance that provides functionality as both a carrier and as a reducing agent can be desirable. One such substance is a purified vegetable oil, such as soy oil, which contains a certain content of oleic acid. Such a purified soy oil is employed as the carrier/reducing agent. In an exemplary embodiment, a purified soy oil having a 22% oleic acid content is employed; however, oils having higher or lower oleic acid content may also be advantageously employed, as can oils which contain other unsaturated fatty acids. Any suitable ratio of carrier to copper sulfide, iron (II) acetate, or other organometallic reactant can be employed, e.g., 0.1 to 100 parts by weight of carrier to 1 part by weight copper sulfide, iron (II) acetate, or other organometallic reactant; however, in certain embodiments higher or lower amounts of carrier can be employed. In an exemplary embodiment, the copper sulfide digenite phase, iron (II) acetate, or other organometallic reactant and the purified soy oil containing 22% oleic acid as the process ligand (carrier-reducing agent) are pre-mixed at a weight ratio of part copper sulfide digenite phase, iron (II) acetate, or other organometallic reactant to 4 parts carrier containing a process ligand. The suspension of copper sulfide digenite phase can be stored prior to use and is referred to herein as OMC-1. OMC-1 can be listed on a safety data sheet (SDS) as “non-hazardous” per the Globally Harmonized System (GHS). In other embodiments, a reactant comprising iron (II) acetate is referred to as OMC-2, and a reactant comprising copper (II) is referred to as OMC-3.

In certain embodiments, a process additive to provide activity as a stabilizer is optionally employed. This stabilizer can provide a fixed wiping surface to facilitate distribution of the copper sulfide, iron (II) acetate, or other organometallic reactant throughout the vulcanized rubber matrix in the mixing-grinding process. This surface can be provided in the form of solid particulate matter having properties of porosity or surface texture combined with structural rigidity and resistance to a force applied to the surface of the particle under conditions of the mixing-grinding process, wherein the copper sulfide is supported on the surface. The solid particulate matter can also provide a non-compressible medium in the mixture, which aids in strain distortion of the copper sulfide's, iron (II) acetate's, or other organometallic reactant's molecular structure in the reactor, furthering the superposition efficiency of the copper sulfide, iron (II) acetate, or other organometallic reactant. Suitable solid particulate matter can include, e.g., minerals, metal alloys (e.g., nickel-chrome, stainless steel, 602A alloy), metals or metal oxides (e.g., iron, nickel, copper, aluminum, zinc, lead, tin, tungsten, titanium, molybdenum, nickel, tantalum, or oxides thereof), oxides, carbides, nitrides, borides, silicates, graphite, ceramics, refractories, sintered metals or other materials, and the like. These can include the oxides of silicon, aluminum, magnesium, calcium, and zirconium. Nonporous materials can be employed, but high surface area and/or porous solid particulate matter can offer advantages as supports, e.g., in constraining the copper sulfide. Such materials can have a surface area of approximately 50 m²/g to 1000 m²/g (e.g., 100-500 m²/g) but higher and lower surface areas can also be employed. The support particles can have an average diameter of from about 10 nm or less to about 1 mm or more, e.g., 100, 500, or 1000 nm to 0.01 mm, 0.1 mm, or 1 mm. In some embodiments, the support is from 30 mesh down to 500 mesh, e.g., 40, 50, 60, 70, 80, or 90 mesh down to 100, 150, 200, 250, 300, 350, 400, 450, or 500 mesh. Supports that are typically employed as heterogeneous catalyst supports for chemical processing may advantageously be employed, e.g., alumina, silica, titanium oxide, zeolites, etc. However, silica offers advantages in that it is a relatively lower-cost material with suitable properties than the more exotic supports.

While copper sulfide, iron (II) acetate, or other organometallic reactant supported on a solid is typically employed, in certain embodiments the copper sulfide, iron (II) acetate, or other organometallic reactant can be employed without the need for such a stabilizer.

An example of a suitable solid particulate material is silica, e.g., in the form of amorphous precipitated silica powder (APSP). An exemplary method involves dry mixing-grinding the copper sulfide in digenite form, iron (II) acetate, or other organometallic reactant with an APSP stabilizer, e.g., PPG's, HI-Sil 134G micro granules, at a ratio in the range of 1:10 to 1:50 (digenite:134G); then adding to 30 mesh (600 micron) ground tire rubber (GTR) such that the copper sulfide, iron (II) acetate, or other organometallic reactant is kept in the range of 1-2% of the initial GTR weight when the dry compound copper sulfide, iron (II) acetate, or other organometallic reactant/APSP is added to the GTR before entering the continuous reactor vessel. Such a supported copper sulfide, iron (II) acetate, or other organometallic reactant is sometimes referred to herein as a doped ceramic frit (DCF). A DCF prepared using the “N2, BET-5 Method” will have a surface area in the range of 140-190 m²/g. An exemplary material is a nano-precipitated silica of 160 m²/g surface area. For a DCF within this surface area range, typically approximately 1-2 parts by weight DCF to 100 parts by weight GTR is employed; however, higher or lower amounts of DCF to GTR can also be employed.

This mixing-grinding of the copper sulfide, iron (II) acetate, or other organometallic reactant into micro-pores of APSP, which has a surface area of approximately 160 m²/g, provides a fixed wiping surface for distributing the copper sulfide, iron (II) acetate, or other organometallic reactant throughout the GTR. It also provides a substantial increase in a non-compressible medium, which aids in strain distortion of the copper sulfide, iron (II) acetate, or other organometallic reactant molecular structure in the reactor, furthering the superposition efficiency of the copper sulfide, iron (II) acetate, or other organometallic reactant in the process. In an exemplary embodiment, OMC-1 is mixed with the stabilizer at weight ratio of 5:1; however, in other embodiments higher or lower amounts of OMC-1 to stabilizer can be employed, e.g., from 1 to 100 parts OMC-1 to 1 part stabilizer. The OMC-1/stabilizer mixture is typically combined with the GTR at a weight ratio of 4:96; however, higher or lower amounts of OMC-1/stabilizer mixture to GTR can also be employed, e.g., 0.5 to 10 parts by weight OMC-1/stabilizer mixture to an amount of GTR sufficient to provide 100 parts by weight total of OMC-1/stabilizer mixture plus GTR. In another exemplary embodiment, OMC-2 is mixed with the stabilizer at weight ratio of 5:1; however, in other embodiments higher or lower amounts of OMC-2 to stabilizer can be employed, e.g., from 1 to 100 parts OMC-2 to 1 part stabilizer. The OMC-2/stabilizer mixture is typically combined with the GTR at a weight ratio of 4:96; however, higher or lower amounts of OMC-2/stabilizer mixture to GTR can also be employed, e.g., 0.5 to 10 parts by weight OMC-2/stabilizer mixture to an amount of GTR sufficient to provide 100 parts by weight total of OMC-2/stabilizer mixture plus GTR. In yet another exemplary embodiment, OMC-3 is mixed with the stabilizer at weight ratio of 5:1; however, in other embodiments higher or lower amounts of OMC-3 to stabilizer can be employed, e.g., from 1 to 100 parts OMC-3 to 1 part stabilizer. The OMC-3/ stabilizer mixture is typically combined with the GTR at a weight ratio of 4:96; however, higher or lower amounts of OMC-3/stabilizer mixture to GTR can also be employed, e.g., 0.5 to 10 parts by weight OMC-3/stabilizer mixture to an amount of GTR sufficient to provide 100 parts by weight total of OMC-3/stabilizer mixture plus GTR.

Desirable end-use applications of such a copper sulfide, iron (II) acetate, or other organometallic reactant derived tire particulate include new tires and shoe soles, which traditionally use a silica powder in formulations to improve strength and cut resistance, which benefit from use of the copper sulfide, iron (II) acetate, or other organometallic reactant doped silica to partially or wholly replace such filler(s). Added performance is also obtained from the elastomer component.

In a process of one embodiment, the GTR is prepared for use, e.g., as an asphalt modifier or in other applications, in a waterborne system processed in a high shear mixer as described elsewhere herein (e.g., a twin arm Banbury or sigma blade mixer). The use of various OMCs as described herein are contemplated, with ferrous (Fe⁺⁺) acetate offering advantages in certain embodiments, e.g., in terms of cost effectiveness. Ferrous acetate is typically employed as an OMC dissolved in a water-based medium. For example, a mixture of water and GTR, optionally with other components, can be used to solubilize the ferrous acetate. An amount by weight of water present to GTR can be selected based on ease of processing and/or an amount of water to suitably dissolve the ferrous acetate, with amounts of 1-4 parts by weight water to 1 part by weight GTR, e.g., 2 parts by weight water to 1 part by weight GTR, being suitable for use.

Certain OMCs are sensitive to oxidation under certain reaction conditions. For example, Fe⁺⁺ acetate can oxidize to Fe⁺⁺ acetate in an aqueous system as described above in the context of GTR for use as an asphalt modifier. Upon oxidation, Fe⁺⁺ acetate becomes insoluble and precipitates, impacting the efficacy of the OMC. Fe⁺⁺ acetate can be maintained in a water soluble form through the presence of a suitable reducing donor (referred to herein variously as a reducing agent, or electron donor). A reducing agent (also known as a reductant, reducer, or electron donor) is an element or compound in a redox chemical reaction that loses or “donates?” an electron to an electron recipient, e.g., Fe⁺⁺⁺ or other oxidation-sensitive OMC (e.g., an OMC that oxidizes under typical reaction conditions such that a reduction in efficacy due to oxidation can be observed). Common reducing agents include ammonia, lithium, sodium, magnesium, aluminum, Br⁻, Cl−, F⁻, compounds that contain the H ion, such as NaH, LiH, LiAlH₄ and CaH₂. NaAlH₂(OCH₂CH₂OCH₃)₂, sodium borohydride (NaBH₄), lithium aluminum hydride (LiAlH₄), diisobutyl aluminum hydride (DIBAH), hydrazine, oxalic acid, formic acid, ascorbic acid, phosphites, hypophosphites, phosphorous acid, hypophosphorous acid, carbon monoxide, nitrite, triphenylamine, ammonia. borane, or the like. Water soluble reducing agents are generally preferred for use with a. waterborne mixture of GTR and an oxidation-sensitive OMC such as Fe⁺⁺ acetate. For example, ammonia or a soluble alkali electron donor (e.g., lithium, sodium, etc.) in suitable form can be employed. It is also desirable in certain embodiments to maintain the waterborne mixture at a basic or alkaline pH, e.g., a pH above 7, e.g., a pH of 8.0. This basic or alkaline pH helps to maintain a reducing medium, such that optimal stoichometry for dislocation of the sulfide bridge by the Fe⁺⁺ acetate is maintained. Optionally in addition to the reducing agent, a basic compound or compounds can be employed to adjust the pH, e.g., hydroxides or similar compounds.

When GTR is to be employed for use as a molded rubber product, it is processed principally through the addition and compounding of interpenetrating virgin elastomers, such as natural rubber (NR) and/or styrene butadiene rubber (SBR). Under these circumstances, it is preferred to conduct the reaction with a minimum amount of water present, e.g., sufficient water to dissolve the OMC, but no excess water or minimal excess water. This can be accomplished by maintaining a ratio of water to GTR of, e.g., 1 part by weight water to 20 parts by weight (or more) GTR. The dissolved OMC typically comprises from 1.0-1.5% by weight of the GTR-containing mass to be processed. This requires that the OMC be water soluble at room temperature to a high degree, e.g., up to 40% or more of solution. This is a high saturation point (high degree of solubility) for many of the OMC materials disclosed herein, but is achieved by ferrous acetate, thus making ferrous acetate particularly suited for use in processing GTR for use as a molded rubber product, or other processes wherein a minimized water content is desirable. If the ferrous acetate is quickly dissolved in water, e.g., a short time (e.g., less than 15 minutes) before it is sprayed and mixed onto the surface of the GTR particles, very little conversion of Fe⁺⁺ to Fe⁺⁺⁺ occurs before the OMC reacts with the methyl carbocation. Accordingly, use of a reducing agent may not be necessary to achieve satisfactory results. In certain embodiments, however, a reducing agent can be employed, e.g., if longer time is required between dissolving and reaction. If alternate OMCs are employed which are not as soluble as ferrous acetate, then typically more water is employed so as to provide a higher load of OMC to the reaction mixture, such that the reaction can be accomplished but generally not as efficiently as when a higher solubility OMC such as ferrous acetate is employed.
Exemplary Process Steps

In an exemplary embodiment, the copper sulfide digenite phase and the process ligand (carrier-reducing agent) which is a purified soy oil containing 22 wt. % oleic acid ligand are pre-mixed at a weight ratio of 1:4 to obtain the OMC-1. The OMC-1 is mixed with the stabilizer (silica nanoparticles of approx. 160 m²/g surface area) at a weight ratio of 5:1. This mixture is then deposited (e.g., sprayed), at ambient temperature, onto the surface of particles of ground tire rubber (GTR)having an average particle size of approx. 600 microns. The OMC-1/stabilizer mixture is combined with the GTR at a weight ratio of 4:96; while simultaneously being vigorously mixed within counter-rotating tines in a pug mill.

Thereafter, the surfaced rubber is dropped into a stuffing box of a co-rotating reactor where it is pushed, under pressure through an annular cavity whereupon a series of rotating lobes create a high pressure impingement upon the coated rubber as it progresses through the annular reactor structure.

The surface of the rotating lobes of the reactor are outfitted with compression bars which subject the rubber to very high pressure pulses. The temperature momentarily rises to over 200° C. at the peak pressure, then subsides until the next compression bar is encountered. During the approx. 36 inches of travel from the stuffing box to the opposite end of the reactor journey, each rubber particle encounters upwards of 120,000 such pulses.

In certain embodiments, a twin shaft, co-rotating mixer extruder including elliptical-shaped lobes can be employed. In one embodiment, the mixer extruder includes twelve (12) equally spaced raised, ladder type bar/lugs machined onto the circumference of the lobe such that as the lobes pass over the respective profile of the opposing lobe the mixture is impinged into a 0.010″ nip for about ¼″ of the travel. The twenty-four pulses per revolution provided in such a mixer extruder help to open up the partially de-linked rubber particle and drive the copper sulfide reactant deeper into the GTR morphology until it reaches a desired size and reduced cross-link density. Any suitable number of lobes can be provided, e.g., fewer than 12 or more than 12, e.g., 6-24 lobes, 3-36 lobes, etc. Other nip distances can also be employed, e.g., 0.005″ to 0.1,″ 0.005″ to 0.05.″ Other distance of travel can be employed as well, e.g., ⅛″ to ½″, ⅙″ to ⅓″, etc. While mixer extruders as described herein can be employed, other reactor configurations described herein can also be employed, e.g., horizontal compression reactors or the like.

In the case of a copper sulfide reactant, the presence of the oleic acid ligand on the surface of the copper sulfide, stabilized by the surface of the precipitated silica, reduces the resident sulfur in the rubber crosslink, whereupon it is transferred to the copper ion rich digenite lattice until the copper ion is reduced to become Cu^{±0}; thereby yielding a covellite phase. Thus, when added to a vulcanized rubber matrix such as GTR and subject to reaction as described above, the baseline copper sulfide (digenite phase) is converted to a Group III copper sulfide (covellite phase).

In certain embodiments, electronic probes can advantageously be employed to bathe the process with microwave radiation, whereby the final sulfur reduction process is adjusted/tuned as desired.

In addition to the other properties described above, the precipitated silica and soy oil components can also be useful elements in the final compounding of the thermotropic rubber, as a reinforcement and softener-plasticizer, respectively.

### Exemplary Processes

In its simplest form, the process can be a straightforward “dry-mix” process where the reactant in pure form or supported form is admixed with GTR, and the admixture subjected to conditions of pressure, e.g., high pressures as described elsewhere herein, advantageously as pulses of pressure. Reactors suitable for applying pressure are described elsewhere herein. In certain other embodiments, however, water can be added to the process in smaller (e.g., 5% by weight) or larger (50% or more by weight). These process variations are described below.
Slurry Process

A solution or partial solution (suspension) of the iron (II) acetate or other OMC soluble in water or another suitable solvent (e.g., an alcohol such as methanol or ethanol, or an ether or glycerol) or mixture of solvents is provided, which is then heated (e.g., to a temperature of 150° up to the boiling point of the solution or suspension) and added to pre-heated ELT rubber crumb. The amount of water employed to prepare the solution can be selected to provide a particular ratio of solution to end-of-life (ELT) rubber crumb. For the same amount of reactant, at a ratio of 2 parts by weight reactant solution to 1 part by weight ELT rubber crumb, an easily pumped slurry of activated ELT rubber crumb is obtained while at a ratio of 1 parts by weight reactant solution to 1 part by weight ELT rubber crumb a thicker slurry is obtained containing more concentrated reactant.

By selecting an appropriate solution amount, equipment costs may be reduced, e.g., use of an agitator can be avoided, or throughput increased, e.g., continuous reactor configurations can be readily employed instead of batch reactor configurations. Water suitable for use can include typical municipal water, or distilled or deionized water; however, particulate levels at or below 100 ppm can be preferred in some embodiments. An advantage of employing the reactant in solution or suspension form includes efficiencies and greater ease of handling the resulting activated ELT crumb rubber, which can be in a flowable state or more proces sable state when worked in the reactor, which can reduce reactor time by up to 20% or more. While not wishing to be bound by any particular theory, it is believed that a solution of the reactant assists in wetting the shoreline of the ELT rubber crumb particles, thereby placing more reactant in contact with the surface of the ELT rubber crumb particles than is the case for dry reactant particles. Mechanical working by the reactor then acts to break up air pockets, further coating the ELT rubber crumb particles. At a reactor pressure of 80 to 100 psi, a steam phase is generated from the solution that gives a more uniform reaction than when dry reactant particles are employed. This enables reactor run times when a reactant solution is employed to be reduced by 50% or more compared to that for dry reactant particles, with the same degree of interlinked substitution achieved. However, in some embodiments dry coating, or coating in the presence of an amount of water, can advantageously be employed to prepare a mixture of ELT rubber crumb and OMC or other reactant.

The activated ELT rubber crumb (e.g., an admixture of crumb rubber, reactant, and optional additional components) in certain embodiments can be transferred to a reactor, e.g., a roller mill, a horizontal compression reactor, or other reactor as disclosed herein. The reactor can be operated at ambient temperatures or temperatures up to 250° F. or higher, e.g., at a temperature of from 242° F. to 248° F. (or a higher or lower temperature, in certain embodiments, e.g., 225° F. to 265° F., or 235° F. to 255° F., or 240° F. to 250° F.), where it is kneaded or masticated to a gum-like state. Sampling of the kneaded product can optionally be conducted at intervals to determine particle size (e.g., effective particle size as represented by film thickness), wherein the particle size is believed to be indicative of the degree of sulfidic metathesis. Additional reactant can be titrated into the kneaded product until a desired particle size target is reached. The pressure applied in the impingement zone of the reactor reduces the activation energy for interlinked substitution, such that the energy released during the reaction exceeds the activation energy required for interlinked substitution under impingement conditions.

A target particle size can be obtained by controlling the degree of sulfidic metathesis, e.g., by controlling the reactor processing time (shorter for larger particle sizes, and longer for smaller particle sizes), or by the amount of reactant added to the ELT rubber crumb. At 5% by weight reactant to 95% by weight ELT rubber crumb, an excess of reactant is present for the amount of sulfur bonds present in typical ELT rubber crumb. A stoichiometric amount of reactant can be employed when maximizing sulfidic metathesis. High degrees of interlinked substitution, e.g., >90% interlinked substitution, are typically observed when a mixture of 4 wt. % reactant to 96% ELT rubber crumb is employed. A mixture of 3 wt. % reactant to 97% ELT rubber crumb will leave a significant amount of sulfur bonds present. In certain embodiments it can be desired to maintain a certain degree of the original vulcanization (e.g., approximately half, or one quarter, of the sulfur bonds remain intact) so as to impart desirable properties to the resulting product (e.g., tenacity, elasticity, etc.) when employed in certain applications (e.g., black masterbatch for producing rubberized asphalt or specialty rubber products). In these applications, a mixture of 2 wt. % reactant to 98% ELT rubber crumb can employed. The resulting interlinked substituted rubber material exhibits good tenacity while having a particle size of <1 μm and can be blended homogeneously into a black masterbatch without impacting critical properties.

As a final step in the process when a reactant solution is employed, the product subject to sulfidic metathesis can optionally be subjected to a dehydration step by heating at or below 250° F. It is believed that the presence of micronized water in the activated ELT rubber crumb may inhibit metathesis of the sulfur bonds. Further heating at temperatures of 285° F. may remove this micronized water and achieve some further amount of sulfidic metathesis. Alternatively, a product containing some degree of water in it may be a desired end product, e.g., for processing at temperatures of 250° F. to 290° F.

Once the desired particle size target is reached, the kneaded or masticated product can optionally be treated with an agent that neutralizes any unreacted reactant. Any suitable neutralizing agent can be employed; however, it is typically preferred to employ a terminally hydroxylated polyethylene (e.g., polyethyleneglycol, CAS 25322-68-3) or a polyethylene copolymer with hydroxyallyl side chain functionality, or derivative thereof. The neutralizing agent is typically used at 0.05 to 0.1 parts neutralizing agent per hundred parts rubber (by weight); however, higher or lower amounts may also be employed in certain embodiments. Other post treatment processes can also be conducted, including any other processes that virgin rubber is subjected to, e.g., grafting to incorporate other polymeric chains to yield a thermoset, thermotrope or thermoplastic product.

The interlinked substitution process of the embodiments offers advantages for reclamation of rubber. For example, no outgassing or pH change is observed during the process or in the interlinked substituted product, which was in the form of sub-micron sized particles, indicating that a stable interlinked substituted product was obtained that is capable of vulcanization. The process offers advantages in that it does not utilize or generate any dangerous or hazardous chemicals, and in that no exogenous substances are generated that would significantly impact the usefulness of the resulting product in applications where virgin rubber is typically employed. Depending upon the application, a higher or lower degree of interlinked substitution may be desirable. For example, in uses such as outdoor carpet backing, roads and roofs, a lower degree of interlinked substitution (partial interlinked substitution) may yield an acceptable product, whereas for uses in high performance articles such as auto tires, a product having a higher degree of interlinked substitution may be desirable. The methods of the embodiments can be adapted to produce product that is partially interlinked substituted, up to highly interlinked substituted and similar in performance to virgin rubber.
Auxiliary Polymer Process

The iron (II) acetate (or other organometallic compound (OMC) as described herein) is mixed into warm water (e.g., ambient temperature, or other suitable temperature, e.g., greater than 0° C. and less than 100° C., or from 5-45° C., or from 10-35° C., or from 20-25° C.) at approximately 20 wt. % concentration (e.g., approximately 20 grams iron (II) acetate to approximately 80 grams water), then optionally blended with a waterborne version of an auxiliary polymer (AP), then ‘dry mixed’ with crumb rubber (e.g., 30 mesh end-of-life tire crumb rubber) in suitable mixer, e.g., a ribbon blender or any other mixing apparatus as described herein, thereby making a damp, non-agglomerating mixture. The auxiliary polymer can be an elastomer, e.g., butadiene, natural rubber, styrene butadiene rubber, isobutylene-isoprene rubber, styrene-1,4-cis polybutadiene polymer, trans-1,4-polyisoprene, cis-1,4-polyisoprene, natural polyisoprene, synthetic polyisoprene, chloroprene rubber, halogenated butyl rubber, nonhalogenated butyl rubber, silicone rubber, hydrogenated nitrile rubber, nonhydrogenated nitrile rubber, or 1,2-high vinyl butadiene.

While 20% concentration for the iron (II) acetate can advantageously be employed, in other embodiments higher or lower concentrations can be employed, e.g., 10-30 wt. %, or 15-25 wt. %. Any suitable ratio of AP to OMC solution can be employed, e.g., 1 part by weight AP to 0.01 part by weight OMC solution, or 1:0.1, or 1:1, or 1:10, or 1:100, or any ratio in between. The process for mixing the OMC solution (e.g., with or without AP) and crumb rubber offers a number of advantages. For example, the use of selected auxiliary polymers provides the ability to sequester polyaromatic hydrocarbons (PAH). The final cros slink requirements can be tailored for a particular end use (e.g., a blend with virgin material to make a better tire, or to achieve higher tensile or elongation properties for an adhesive).

Once the damp, non-agglomerating mixture is prepared, it can be processed into a monolithic rubber macrostructure, e.g., as described elsewhere herein. The high rubber concentration process can also provide improved processability through the compression and shearing action of a roll mill and/or a twin screw, co-rotating, self-wiping mixing extruder to form the monolithic rubber macrostructure. In certain embodiments, an 80:20 (by weight) blend of dry crumb rubber:aqueous OMC/AP solution (e.g., having a solids residue range of 27-75 wt. %, or 35-50 wt. %) yields a satisfactory product having acceptable properties. While an 80:20 (by weight) blend of dry crumb rubber:aqueous OMC/AP compound can advantageously be employed, other ratios can also be employed, e.g., 1:20, 2:20, 5:20, 10:20, 20:20, 30:20, 40:20, 60:20, 90:20, 100:20, 120:20, 140:20, or 160:20. The low moisture content evaporates from the infused energy during the compression/shearing/compression excursion, offering benefits in terms of a dry product having minimal water content.

A further advantage of the process is that less reactor processing time can be needed, as the OMC/AP mixture is uniformly distributed over the initial surface of the crumb rubber, and as the rubber moiety is opened up it assists in minimizing chemical reactant displacement on reactor parts due to ‘buttering’. This free OMC/AP assists in the re-wiping of the freshly exposed inner crumb rubber structure as it is leafed by the mechanical elements.

In a variation of the process, the process is conducted in the absence of an AP.

### PTR Particle Size Minimization

Depending upon the application, different PTR particle sizes may be suitable. For example, PTR having a ˜50 micron particle size may be a desirable commodity product for various uses. However, in certain other embodiments, a smaller yet discernable particle size, e.g., ˜10 microns, or even less than 1 micron (sub-micron) is desirable. Such smaller particle size PTR can be sold at a premium, but can be difficult to achieve with precision (by avoiding over-processing into rubber with no discernable particle size).

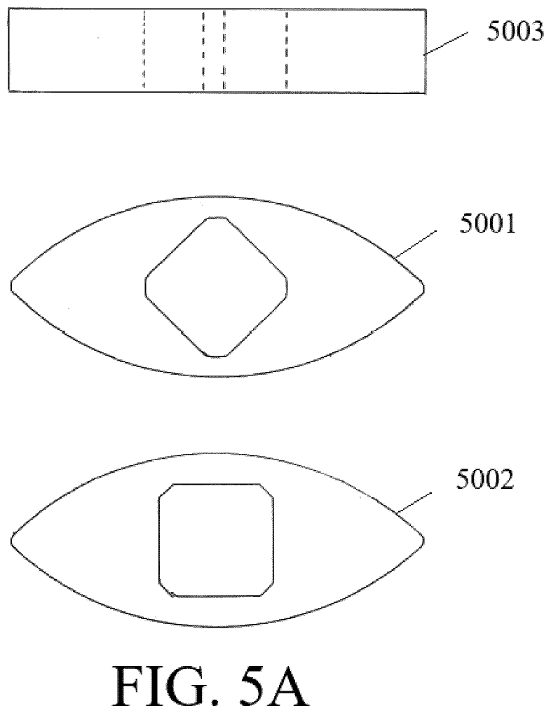

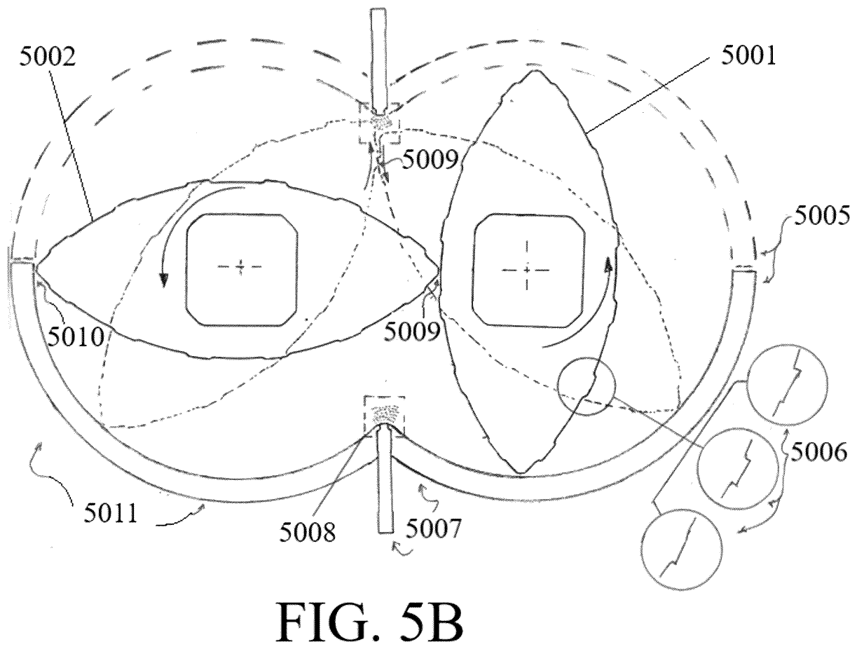

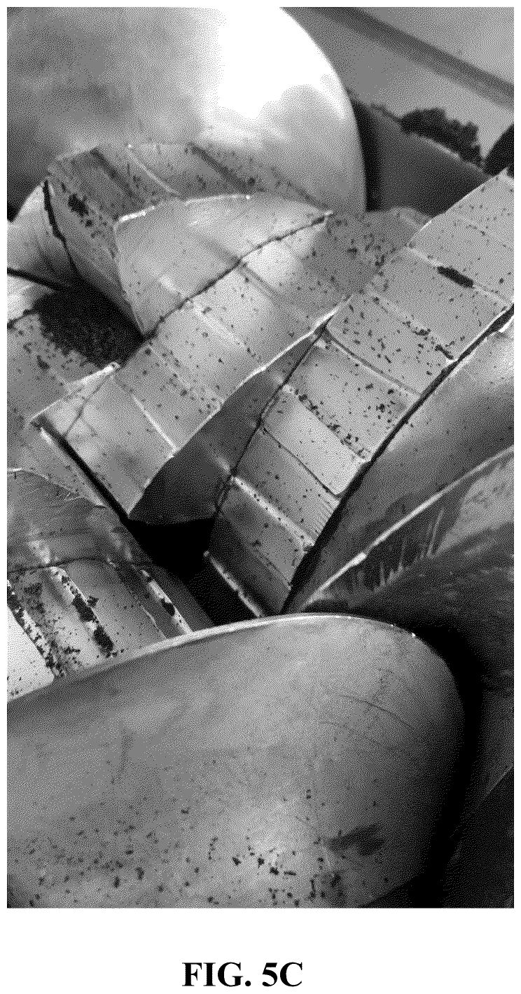

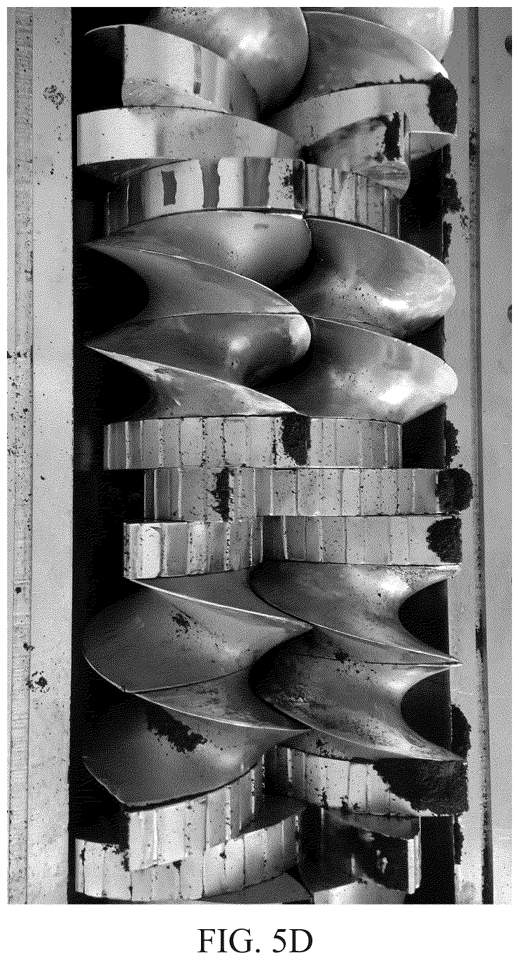

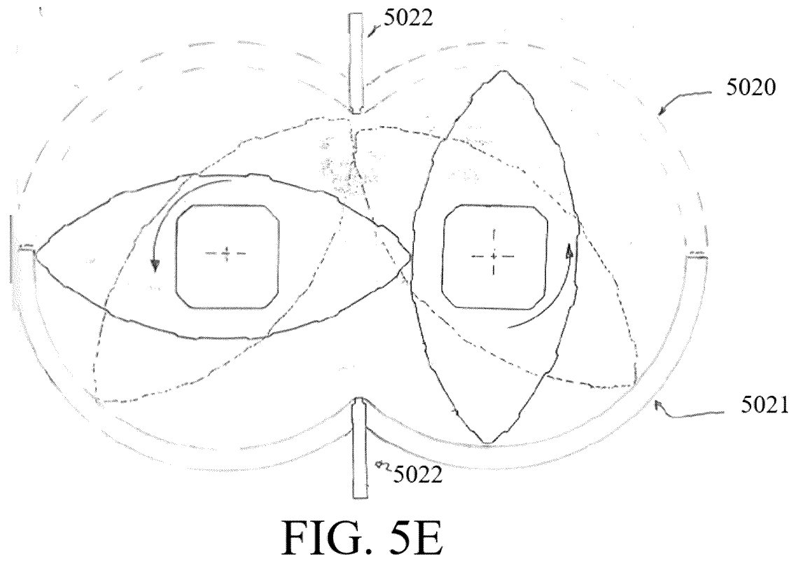

For example, 600 micron GTR was subjected to a continuous process to yield a PTR particle in the 50-75 micron size range. This process utilized three steps. In the first step, the dry GTR particles were coated with a suitable OMC (reactant) in a spray-mixing auger/pugmill. The resulting dry-coated particles were then fed through a co-rotating lobed bar compression gauntlet, such as is depicted in FIG. 5A. The processed particles were then squeezed with a screw through a high shear knife-die assembly. The resulting particles were in a range of from 50-75 microns in size. Experimentation revealed that adjustments to this particular process's apparatus gap(s), temperature, and feed rate and redundant, multiple passes throughout this process apparatus resulted in very little additional positive effect on final particle size (no significant further particle size reduction).

Experiments were conducted whereby dry-coated GTR was processed using a single screw (auger) lab extruder, armed with one or more tiny orifice breaker plates, and run at very high pressures (400-600 bars). This modification to the apparatus proved effective at reducing the particle size into the more valuable, ˜10 micron or less size range. However, the initial capital outlay and maintenance costs result in a higher overall cost offsetting the increased value of the product.

Through further experimentation, it was found that the three-step continuous process could be modified to yield very small particle size PTR. Hardware adjustments to the third step of the apparatus were made to create a controlled but moving pack-seal composed of the in-process rubber between the end of the auger and the backside of the knife (which is attached to the auger). This strategically inhibited transfer rate impinges the rubber into a twisting, high viscosity flow propelled between the mechanical ramming forces of the material from the auger, whereupon the temperature rises from near ambient to 300° F. or higher. This impingement zone. The dwell time in the impingement zone can be regulated by auger motor speed, knife shape, auger barrel fluting, and/or exit die configuration. A longer dwell time can be employed to produce a smaller particle size.

Further, by strategically introducing water into the first step of the three-step continuous process, the impingement zone effectively become as hydro-cracking retort that so thoroughly fractures the size-diminished, core moiety of the rubber particles that the emerging rubber pulp may be ‘finished’ through tight-gapped calendar rolls into a film composed substantially of sub-micron particles (<1 micron). Any suitable amount of water can be employed, e.g., from 1% or less by weight to 10% or more by weight, optionally 3% by weight to 7% by weight, with water comprising 5% by weight of the feed into the first step of the reactor generally producing suitable results.

As the semi-melt exits the die, it spits steam which was captured and analyzed. It has been determined that secondary, beneficial reactions which can only be activated by the vapor stage environment may be introduced through the water medium.

### Modification of Original Process Oil (OPO) Component in EOL Tire Rubber

In order to achieve satisfactory dispersion of carbon black particles, the mechanical and hydrodynamic forces applied during carbon black particle dispersion in rubber must be greater than the forces of interaction between adjoining carbon black particles. However, the graphitic crystalline state present in the carbon black particles makes the breakup of agglomerates and aggregates and subsequent dispersion in rubber compounds difficult. Hence, carbon black particles with greater crystalline content typically need more energy for agglomerate breakup and eventual dispersion of carbon black in rubber compounds.

Carbon black crystals (individual particles) display a variety of greatly variable shapes, e.g., spherical particles, polyhedric particles, cylindrical particles, platelike particles, etc. These shapes can be classified into three different types: isometric compact, nonisometric compact, and irregular porous noncompact. Van der Wall forces between the elements of the crystal resist cleavage of the crystal during distribution and dispersion in the rubber compounding phase of tire composite manufacturing.

An oil absorption process is used to indicate the structure of carbon black. The process utilizes, e.g., dibutyl phthalate (DBP) in a DPB absorption (DBPA) process. From this test, an oil absorption number (OAN) can be obtained, which indicates the cubic centimeters (milliliters) of dibutyl phthalate absorbed by 100 g of carbon black (CB) under specified conditions. Oil absorption number (OAN) is a measure of the ability of a carbon black to absorb liquids. This property is a function of the structure of the carbon black. Either dibutyl phthalate (DBP) or paraffin oil is acceptable for use with standard pelleted grades, including N-series carbon blacks found in ASTM D1765, although OAN testing using paraffin oil on some specialty blacks and powder blacks might result in unacceptable differences as compared to OAN testing using DBP oil. While studies have shown the two oils to give comparable precision, paraffin oil offers the advantage of being non-hazardous. ISO 4656:2012 specifies a method using an absorptiometer for the determination of the oil absorption number of carbon black for use in the rubber industry.

The value of OAN is related to the structure level of CB. A greater OAN number indicates a higher structure level (higher degree of crystallinity) of carbon black. The compressed sample (CDBP) absorption technique is also used. The CDBP utilizes the void-volume technique under a broad angle, considered by some to be a more absolute technique. That said, the predicted volume by these tests falls well short of being a reliable measure of the absolute internal volume of CB agglomerates which have undergone the vigorous, electro-mechanical PTR Reactor process.

Carbon black can be divided into two parts, the amorphous part and the graphitized part. The existence of graphitization in carbon black often results in a wrapping of the amorphous part, thus leading to a graphite-like structure on the carbon black particle's surface. These surface structures are often in contact with the external environment, and therefore will contain some common elements such as oxygen and hydrogen as well as carbonaceous ligands.

Conventional compounding first incorporates carbon black powders into the rubber. Subsequently, the powder rubber matrix is “wetted” by a process liquid, which may be a bio-resin or other petroleum based low volatile oil such as treated distillate aromatic extracted (TDAE). The penetration of liquid into the agglomerate is a classic example for this step.

The graphitized surface of the CB resists the process oil absorption, but the lubricating effect by way of adsorption between the graphitized surface and the rubber polymer lowers Mooney viscosity and greatly facilitates the final tire matrix compounding. This structural, adsorptive position is conventionally thought to be the mean, inter-morphological molecular state throughout the life of the tire. However, after the EOL tire is granulated and further processed via the two-phase PTR Reactor, a massive displacement and transformation of the adsorptive OPO occurs, as described below.
PTR Reactor Process and Resultant Effect Upon Original Process Oil

The PTR reactor (Reactor) simultaneously induces four forces upon the approx. 600 micron, vulcanized ground tire rubber (GTR) particle: 1) mechanical, 2) hydrodynamic, 3) electromagnetic, and 4) electro-chemical. Sulfur-carbon bonds securing the sulfur bridge between elastomer strands are cleaved and thereby dislocated by a tuned spectrum of electromagnetic energy provided by the chemistry involved. Each individual GTR moiety is typically subjected to more than 200,000 “gentle” high compression and high shear energy pulses during its excursion through the Reactor. By virtue of the crosslink dislocation, the original GTR moiety undergoes a size reduction of three orders of magnitude.

During the size reduction, most of the large CB agglomerates are sheared into much smaller fragments. This opening of the agglomerate density reveals the vast, hydrogen, ligand-rich fractal shoreline of the amorphous structure of the CB.

Nonconductive elastomer polymers become electrically conductive via the conductive carbon black at a critical concentration of conductive carbon black at the adsorptive interface. The factors of positive temperature (IR energy) coefficient (PTC) and negative temperature coefficient (NTC) promote a phenomenon of sudden increase and decrease of resistivity of the OPO. This differential, together with the energetic mechanical-hydrodynamic environment, moves the adsorbed OPO away from the elastomer interface and into the vicinity of the reactive, hydrogen-rich, shoreline cavities of the previously internally bound, amorphous CB agglomerate structure.

Reactions between the displaced OPO and the internal chemistry of the CB, sustained by specific, high energy bursts of electromagnetic bandwidths, a process-generated manifestation of the utilized PTR chemistry, fractionate the hydrocarbon chains of the OPO. This OPO fractionation potentiates the newly-formed, short-chain oligomers to become electro-chemically attached to the CB reactive shoreline. At this stage, the Mooney viscosity of the newly formed PTR has been raised to a level that is approx. two to four times that of the original GTR. Select, possibly reactive, process oil(s) are then added to not only lower the Mooney viscosity to a range that is accommodated by existing rubber mixing equipment, but to facilitate added useful functionality to the PTR.

PTR provides a new opportunity to guarantee a sustainable flow of raw materials for rubber goods worldwide. The above-described, more complete, dispersement of CB and mediation of possible variability associated with OPO, together with the optional selection of, e.g., novel process oils and incremental, select, Reactor-added elastomer grafts also offers the promise of utilizing PTR as a performance enhancement, when compounded with virgin tire rubber materials.

### Reactor Designs

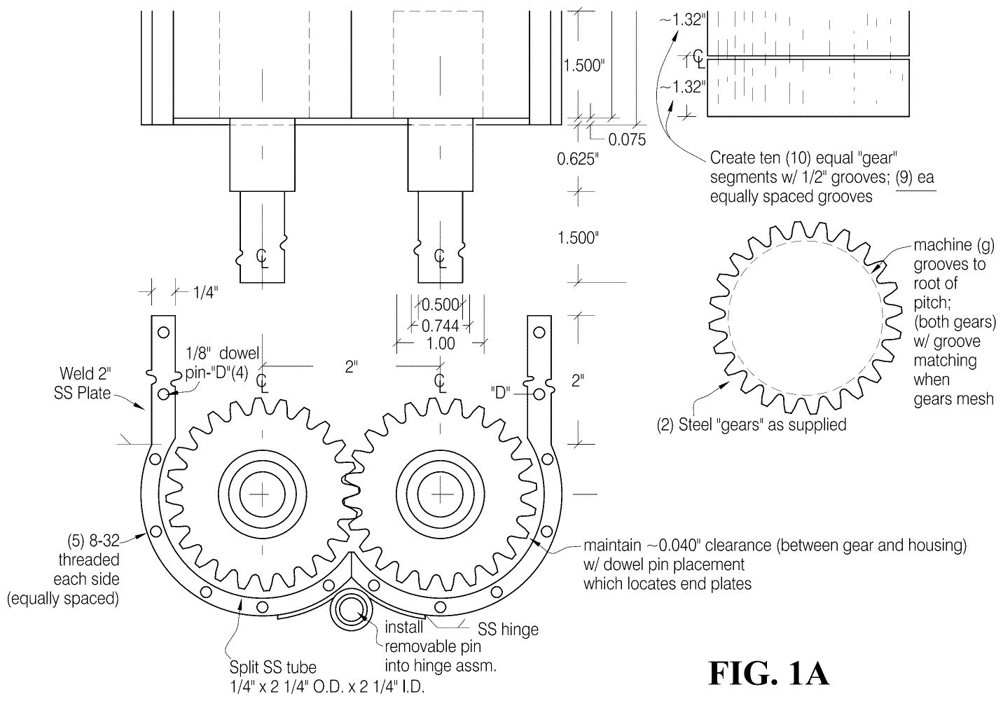

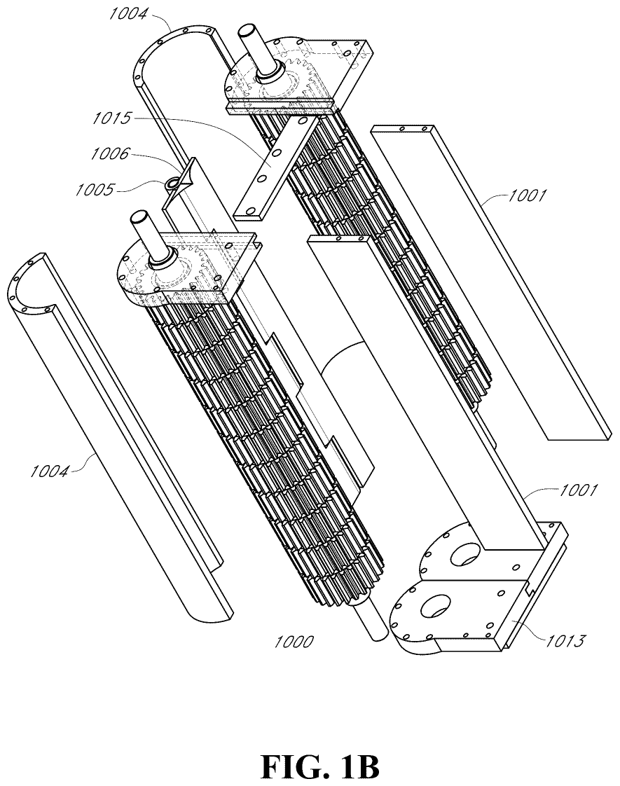

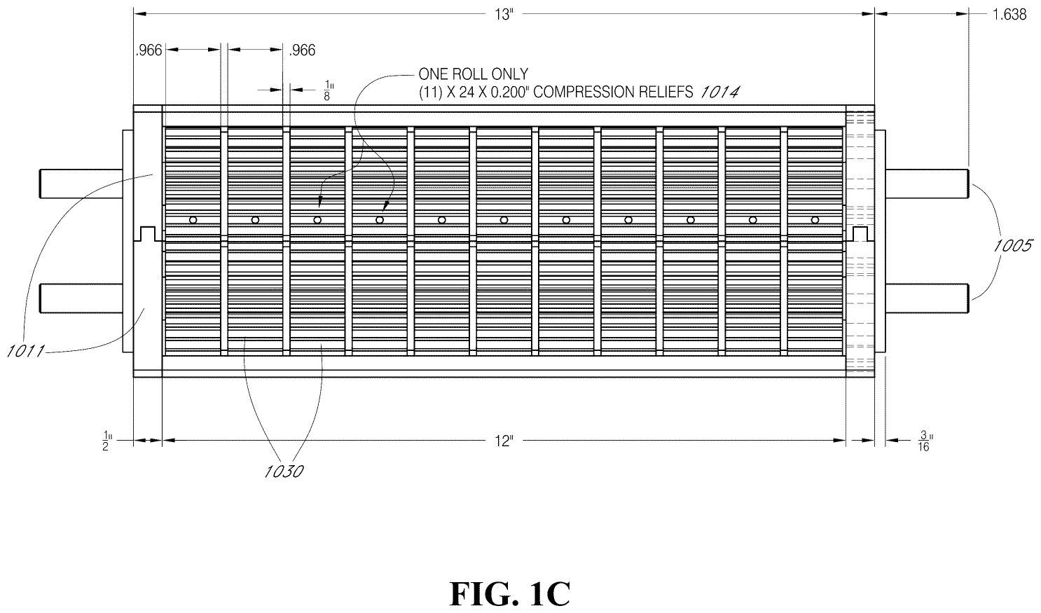

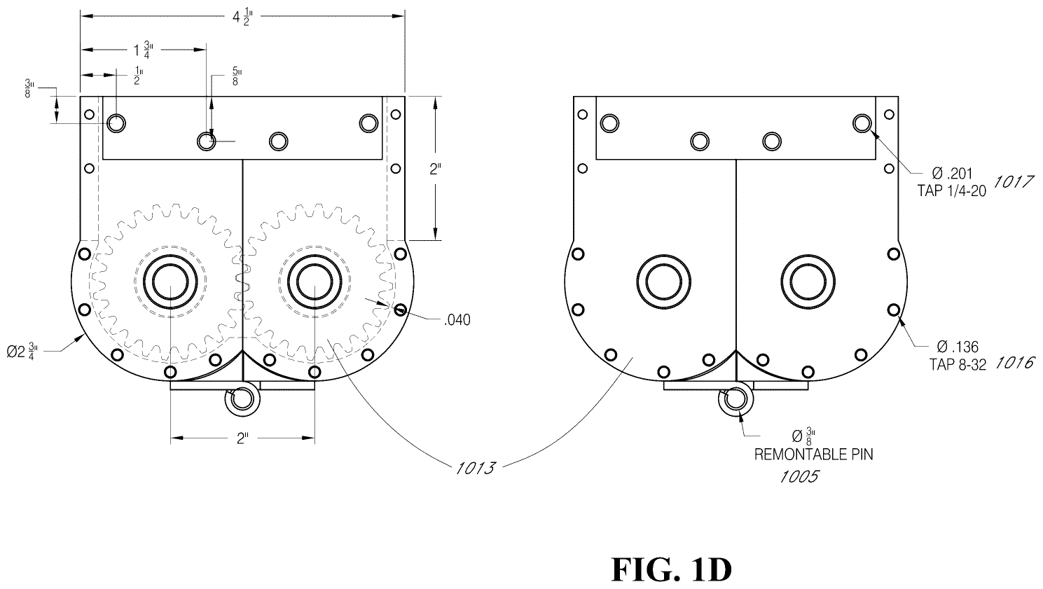

Reactors as depicted in FIGS. 1A-1D, 3A-3C, 4A-4B, and 5A-5E can advantageously be employed in certain embodiments.

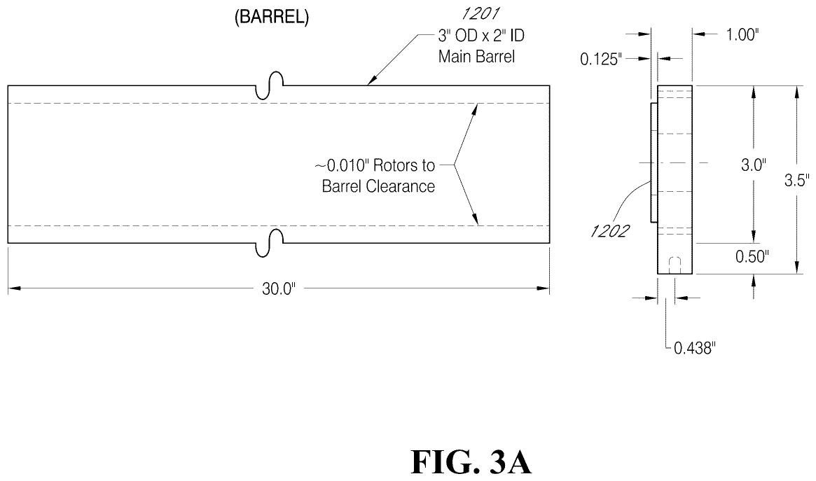

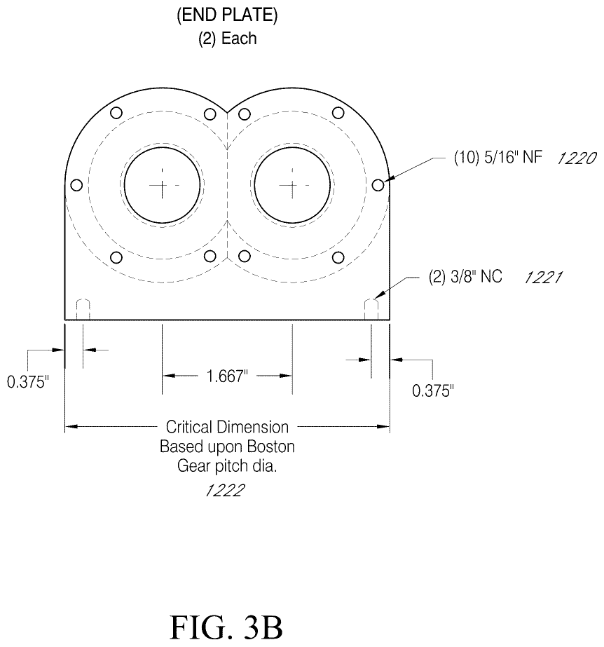

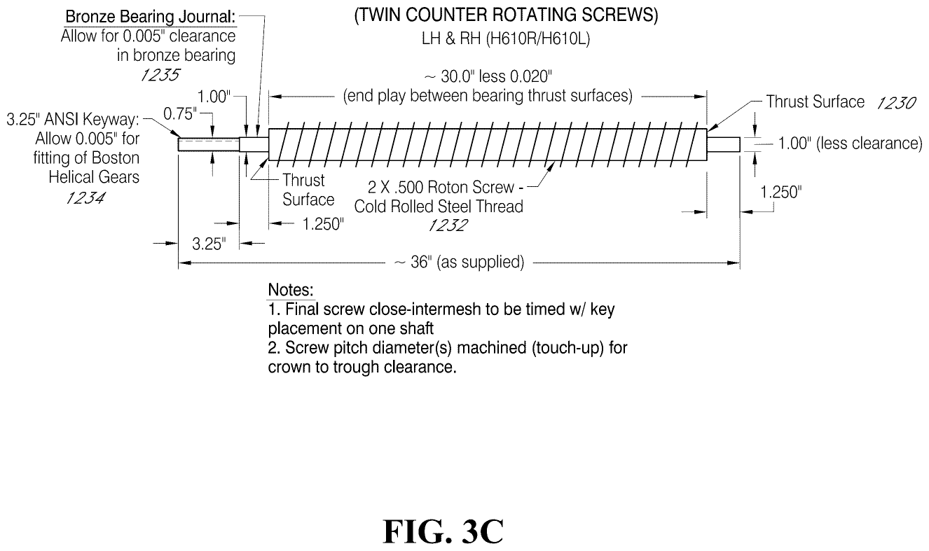

The reactors depicted in FIGS. 1A-1D and 3A-3C are horizontal compression reactors. FIG. 1A depicts a top view and a side view of a small scale reactor and its gears 1000. The gears as provided 1008 are steel and are machined to include machined grooves 1010 to the root of pitch. In operation, the grooves of both gears match when the gears mesh, and maintain ˜0.040 inches of clearance 1007 (between the gear with dowel pin placement and the housing) which locates the end plates. Ten gear segments of equal length (e.g., one segment up to any desired plurality of segments, e.g., up to 10, 20, 30, 40, 50 or more) are employed with nine ⅛ inch grooves equally spaced. The number of grooves and the configuration or depth of the grooves can be adjusted depending upon processing conditions. The gears are placed in a split stainless steel tube 1004 having threaded holes 1003 and welded to stainless steel plates 1001 including dowel pins 1002. A removable pin 1005 fitted into a hinge assembly 1006 secures the apparatus for operation. FIG. 1B provides an exploded view of a horizontal compression reactor showing detail of the gears 1000 of FIG. 1A. The gears, as shown in top view in FIG. 1C include eleven sets of gear segments 1030 with twenty-four grooves 940 and a 0.200″ compression relief 1014 for each gear segment. FIG. 1D shows a view of the end plates 1013 (and transparent view of endplates showing details of gear behind) including taps 1016 and plate 1015 including taps 1017. While the apparatus depicted in the figures can be employed to provide the pressure to the mixture of vulcanized rubber and copper sulfide, iron acetate, or copper acetate (or other reactant), other configurations are also envisioned, as will be appreciated by one of skill in the art, e.g., mortar and pestle, ribbon mixers, high shear dispersers, or the like. In one embodiment, instead of meshing gears, smooth rollers in opposing configuration can be employed.

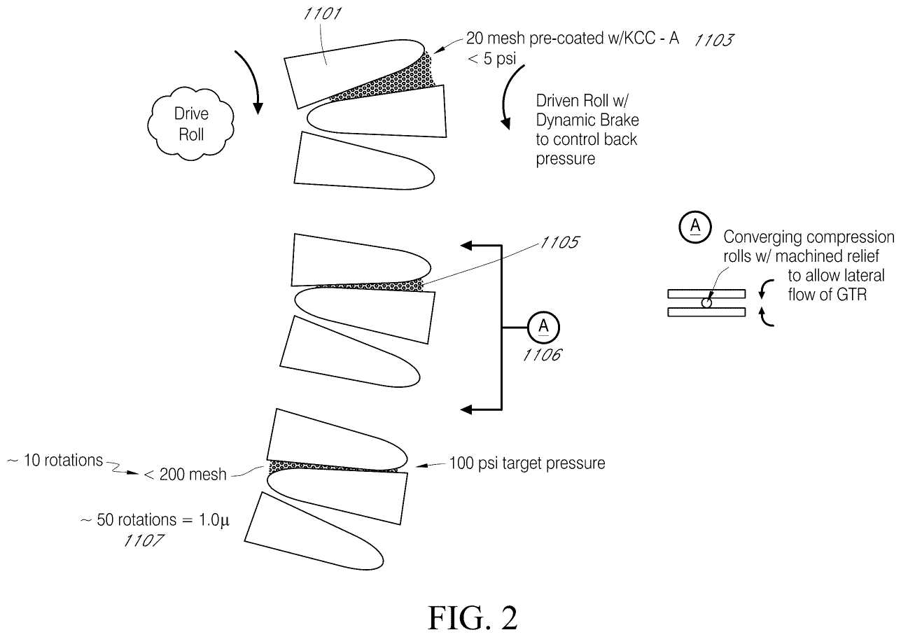

FIG. 2 depicts detail of the meshing gears of the drive roll in operation. The gears are converging compression rolls with machined relief to allow lateral flow 1106 of the reactant coated crumb rubber. A 20 mesh crumb rubber pre-coated with reactant 1103 fills the space between the gears at a pressure of less than 5 psi. As the gears 1101 mesh, the pre-coated crumb rubber 1105 is compressed to approximately 100 psi (e.g., 50 psi to 200 psi, or 75 psi to 150psi, or 80 psi to 125 psi, or higher or lower, depending upon reaction conditions). Ten rotations of the gears (10 applications of compression) reduce the particle size (as determined by screening through a particular mesh size) from 20 mesh to less than 200 mesh 1107. Fifty rotations of the gears (50 applications of compression) reduce the particle size from 20 mesh to approximately 2 μm. The drive roll incorporates a dynamic brake to control back pressure. The resulting product can be processed until a desired particle size less than that of the starting crumb rubber is obtained, e.g., 30 mesh, 40 mesh, 50 mesh, 100 mesh, 200 mesh, 10 μm, 5 μm, 2 μm, 1 μm, or less than 1 μm.

Another reactor design incorporates twin counter rotating screws. The twin screws are in a close intermesh configuration, and are situated in a pair of partial barrels joined together. FIG. 3A shows a side view of one of the barrels 1200. The barrel depicted has a 3 inch outer diameter and a 2 inch inner diameter, is 30 inches in length, and contains a rotor 1202. FIG. 3B shows one of the two end plates 1213 with hold holes 1220, 1221, illustrating the joined barrels configured to enclose the close-intermeshed twin counter rotating screws. The critical dimension 1222 is based upon the Boston Gear pitch diameter. A clearance of approximately 0.010 inches between the rotors of the screws and the barrel wall is provided. FIG. 3C depicts one of the screws, a 0.500 Roton Screw 1232 with cold rolled steel thread. FIG. 3C depicts thrust surface 1230, bronze bearing journal 1235, and ANSI keyway 1234. While the reactor depicted in FIGS. 3A-C includes specific dimensions or materials, the dimensions can be reduced or increased as needed to provide a larger or smaller reactor, and other suitable materials can be substituted.

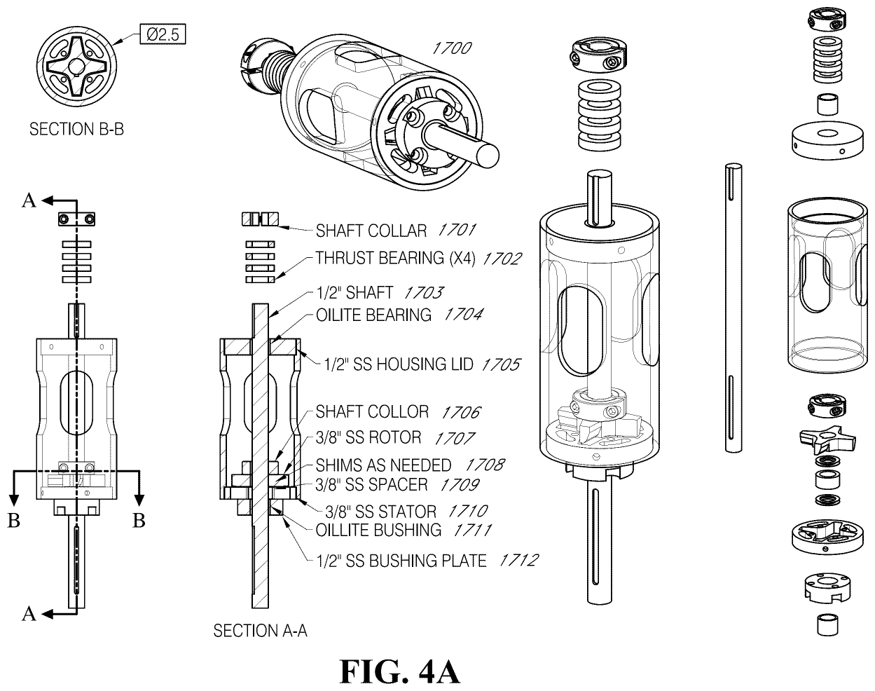

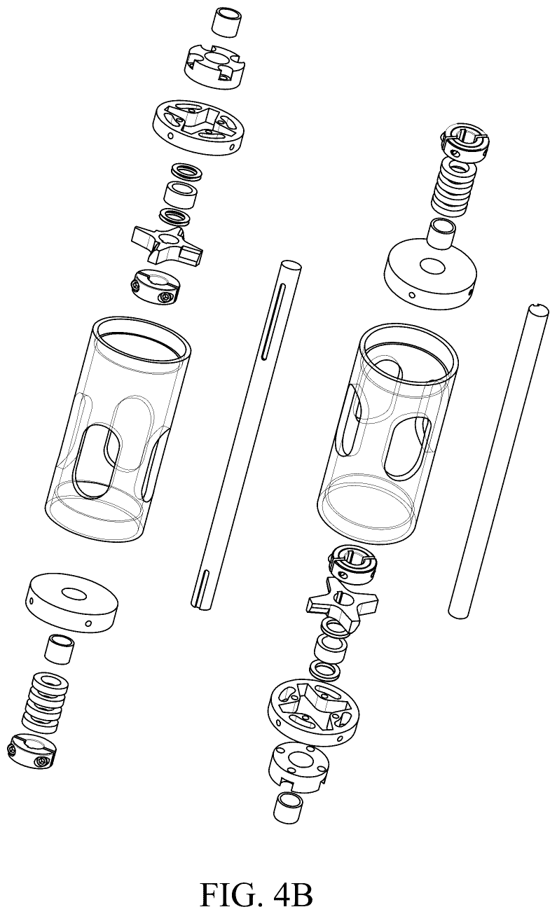

In certain embodiments, an interfusion reactor (IFR) can be employed. It has been engineered to have two, otherwise unexpected capabilities: 1) the high speed mixing action of an open blade mixer, and 2) the impinging wedge action of a mixing extruder. A single stage interfusion reactor is depicted in FIGS. 4A and 4B.

Continuous processing equipment (CPE) including elliptical mixing lobe pairs can also be employed. The CPE base design is a 5″×36″, twin shaft, counter-rotating device powered by a 20 hp, 480v, 3ph motor manufactured by Teledyne Readco in York Pennsylvania, now known as Kurimoto Readco. The twin shafts are configured to accept slide on-and-off spiral transfer flights and 1″ thick elliptical mixing lobe pairs (FIG. 5A) typically made of corrosion resistant, 304 stainless steel or Hastelloy steel.

The spiral and lobe work appliances match to orchestrate the movement and compounding action desired for a particular material, whether it be a power-liquid, powder-powder, or liquid-liquid medium. Square shaft openings in the individual appliances are oriented at 90 degrees or 45 degrees such that when mounted in an alternating position on the shaft(s) they provide a helical progression of pushing or mixing of the material from the barrel entrance, known as a stuffing box, to and through the barrel exit which may be a free flowing or regulated gate.

Typical, original sweep clearances between the barrel surface and the rotating surfaces of the outer circumference of the spiral flights and/or the tips of the rotating lobe(s) is in the range of 0.050″-0.060″, dependent upon the materials being processed; however, larger or smaller clearances can be employed. Clearances between the moving surfaces of the intermeshing lobes is usually closer than between the rotating surfaces and the barrel, for example, in the range of 0.040″-0.050″ (FIG. 5B). FIG. 5C is a photograph showing details of the intermeshing lobes.

The barrel design is typically made of corrosion resistance 304 stainless steel with a chrome inner surface. It is a clamshell configuration and provides thermal control of the process through full length and circumference jacketing. FIG. 5D is a photograph showing details of the spiral flights and the rotating lobes as seated in half of the barrel.

Two primary modifications to the CPE base design are incorporated in an embodiment suitable for reaction of copper sulfide with vulcanized rubber. The design modifications are mutual, reciprocal and complimentary to achieve Atomic-Scale, Particle Interaction (ASPI). The ASPI is achieved by (ONE) a coordinated, substantial increase in: 1) mechanical stress-strain, 2) rate of shearing, 3) pulsed-timed micro-mechanical stress-stain, all modulated by (TWO) an intersecting, variable, high frequency acoustic, quantum field.

ONE consists of providing a series of raised lugs across the width of the original lobe design (see FIG. 5B). These are referred to as stress-strain lugs (SSLs) The height and shape of the lug can vary depending upon the material being processed. Its construction can be achieved by machining the profile desired from a raw blank lobe; three alternatives are shown. Typically, the barrel-to-lobe gap remains the same as the Original Equipment Manufacture (OEM) design. The lobe-tip-to-lug, primary surface can also remain the same as the OEM design, but the closure gap between the raised surface of the lug and the lobe tip can be in the range of 0.10″-0.15″; however higher or lower closure gaps can be employed. The number of lobes and the shape are empirically established, and can vary depending upon application, e.g., 1, 2, 3, 4, 5, 6, 7, 8, 9, 10 or more lobes.

TWO consists of the insertion of piezoelectric transducer driven acoustic horn(s) arranged along the outer barrel and penetrating the barrel through a series of vibration-isolated ports which traverse the barrel jacket and are located at positions selected to strategically influence the ASPI. The high frequency emitters (HFE) operate in the range of 1,000-50,000 Hz.

The following discussion is in the context of processing a copper sulfide coated ground rubber particle (GRP) with a beginning average diameter of 600 microns and an intended, exiting final diameter in the range of 500 nm-10 microns.

At an operating motor speed of 3,500 rpm driven through a 17:1 gearbox the shaft(s) rate of rotation is 205 rpm (however, higher or lower rpm can be employed in certain embodiments). With the shaft-pair configuration of three sets of three pairs of lobes (workstations) pressurized by the forward-squeezing, transfer spirals along the 36″ length of the CPE; the number of pulsed, SSL interactions between the Ground Rubber Particle (GRP) and the lugs is 44,280/min.

The spiral feed system, with no workstations or exit valving will, at 205 shaft rpm, free flow approximately 200 pounds per minute of free flowing GRP. With workstations as described herein and a gate valve at the exit, a 20 hp motor will move about 20 pounds of processed GRP. This equates to subjecting the bulk rubber particle to 442,800 SSLs/min.

Six HFE located three above and three below (FIG. 5B) per workstation, emitting approx. 30,000 pulses per second, provides an accelerated chemical bond disruption.

The “Area of Quantum Field Activity” (FIG. 5B) is a Particle Vortex Cavity (PVC) which is formed by the confluence of the flow of materials along three axis within the CPE barrel: 1) a push-flow from the spiral feed flights which is parallel to the annular cavity axis of the barrel, 2) an upward sweeping motion induced by the left hand lobe perpendicular to the axial push-flow of (1) and 3) a downward sweeping motion induced by the right hand lobe, also perpendicular to the axial push-flow but opposing the flow of (2). Positioning a three HFE acoustic horns (sonotrode) cluster to radiate an acoustic wave into the PVC directly below and above the three lobe workstation creates an opportunity to significantly influence efficiency of the mixing, chemical reaction(s) and size-dissociation of the materials being processed.

The GRP being subjected to the CPE (by way of example) is pre-coated with a copper sulfide-containing mixture in a separate operation, prior to being fed into the CPE. The cluster-timed, HFE propagated ultra-sonic wave will travel through air space between the particles and, upon striking innumerable particle surface(s), interact with the liquid component of the coating thereby forming a cavitation bubble. The formation, growth and sudden collapse of the bubble forms a shockwave. The collapsing bubble shockwave operates at super-sonic speed. The HFE ultra-sonic wave and the particles, both upstream and downstream of the bubble collapse, are moving at sub-sonic speed. This flow of materials around the collapsing bubble are considered isentropic, i.e., they satisfy the Rankine-Hugoniot conditions, and therefore the supersonic shockwave is as adiabatic process transferring no heat or mass between an otherwise thermodynamic system.

The sudden nature of the cavitation shockwave relative to the conditions within which it occurs in the PVC provides an overlapping, electrodynamic force which may be engineered as to amplitude and frequency by tuning the HFE wavelength and timing. One critical measurement of the HFE efficiency is the comparison of the final particle size emitted from the CPE measured against the power consumed by the main CPE drive train. A higher ratio of small particles to constant power consumption is a bulk indication that the settings of HFE by tuning is optimizing its influence.

Each of the aforementioned reactor designs can readily be modified, as will be understood to one of skill in the art, to account for desired throughput, particulars of the reactant mix, footprint requirements, energy requirements, environmental concerns, and the like. While the above reactor designs can advantageously be employed, other reactor designs, as are known in the art for use in processing, e.g., plastics and other polymeric materials, can be adapted for use in the methods herein.

### Exemplary Example 1

The starting material is 100 g of 30 mesh whole tire cold ground tire rubber (GTR). 5.0 grams of iron (II) acetate is provided for interlinked substitution. Reaction time to a “gum state” is approximately 20 seconds. Heat and pressure are generated using a heated mortar-pestle apparatus mounted to a hot plate and pressure calibrated with a 150 RPM drill press assembly.

After 50 cycles at 275° F. and approximately 100 psi, the particle size is reduced to a 90% pass through a 1.0 μm, as measured according to ASTM D 2042. The resulting particles are observed to adhere to other particles, forming a film, indicative of restored side chain functionality (interlinked substitution) resulting from the sulfidic scavenging process. The resulting film is <1.0 μm thick, as measured using a film thickness gauge 0-0.001 mm Yasuda Model 128 or equivalent. A 10% by weight solution in distilled water of the whole tire cold ground tire rubber is prepared as is a 10% by weight solution in distilled water of the interlinked substituted product. No comparative change in pH is observed.

Initial tests are performed per SHRP/AASHTO protocols and showed that substantial flexibility is imparted to a PG 67-10 asphalt binder base when the interlinked substituted product is added. 10% of the interlinked substituted product (<1.0μm) when added to a PG 67-10 asphalt binder base and blended under a high shear Silverson Mixer raises the dynamic shear (as measured by a dynamic shear rheometer) to that characteristic of a PG 82-22 asphalt binder base.

### Exemplary Example 2

### Horizontal Compression Reactor

The starting material is 30 mesh whole tire cold ground tire rubber. The starting material is estimated to comprise approximately 40% by weight rubber by weight and approximately 2.5% by weight of rubber mass of elemental sulfur. Iron (II) acetate in powder form is provided for interlinked substitution. The ground tire rubber and Iron (II) acetate are mixed together (4% by weight Iron (II) acetate to 96% whole tire cold ground tire rubber) and then fed into a horizontal compression reactor.

After a total of 10 cycles through the reactor at 275° F. and approximately 100 psi, the particle size is reduced to <200 mesh, and after a total of 50 cycles through the reactor at 275° F. and approximately 100 psi, the particle size is reduced to approximately 1.0 μm. The resulting particles are observed to adhere to other particles, forming a film, indicative of restored side chain functionality resulting from the sulfidic scavenging process.

Initial tests are performed per SHRP/AASHTO protocols and show that substantial flexibility is imparted to a PG 67-10 asphalt binder base when the interlinked substituted product is added. 10% of the interlinked substituted product (<1.0μm) when added to a PG 67-10 asphalt binder base and blended under a high shear Silverson Mixer raises the dynamic shear (as measured by a dynamic shear rheometer) to that characteristic of a PG 82-22 asphalt binder base.

### Exemplary Example 3

### Micro-Compounder—Dry Reactant

The starting material is 30 mesh whole tire cold ground tire rubber. The starting material is estimated to comprise approximately 40% by weight rubber by weight and approximately 2.5% by weight of rubber mass of elemental sulfur. Iron (II) acetate in dry powder form is provided for interlinked substitution. The ground tire rubber and Iron (II) acetate are mixed together (4% by weight Iron (II) acetate to 96% whole tire cold ground tire rubber) and then fed into a micro-compounder, yielding a mixture of 4% by weight Iron (II) acetate to 96% whole tire cold ground tire rubber.

The mixture is processed in the micro-compounder at 250° F. and approximately 80-100 psi, for a duration of approximately 1 hour, and approximately 750 g of product, comprised of rubbery particles is obtained. The elasticity of one of the particle masses is demonstrated by the mass being stretched.

### Exemplary Example 4

### Micro-Compounder—Aqueous Solution of Reactant

The starting material is 30 mesh whole tire cold ground tire rubber. The starting material is estimated to comprise approximately 40% by weight rubber by weight and approximately 2.5% by weight of rubber mass of elemental sulfur. A sufficient amount of water to dissolve iron (II) acetate is mixed with the iron (II) acetate reactant. The most effective distribution of the iron (II) acetate is achieved by pre-dissolving in warm distilled water (H₂O) at 150° F., at a 5% solution. This is then blended into the dry, ground tire rubber such that the blend becomes a pourable or pumpable slurry. 4 parts by weight iron (II) acetate is provided for 96 parts by weight whole tire cold ground tire rubber. The ground tire rubber and solution of iron acetate are mixed together and then fed into a micro-compounder.

The slurry is processed in the micro-compounder at 250° F. and approximately 80-100 psi, for a duration of approximately half an hour, and approximately 750 g of product, comprised of rubbery particles, is obtained. The resulting product is similar to that obtained from a dry mixture of iron (II) acetate and whole tire cold ground tire rubber in terms of resulting particle size and interlinked substitution, while requiring less reactor time to completion.

During the processing of the GTR/iron (II) acetate slurry, the reactor vessel head space, temperature and pressure are held at a point such that the liquid phase of the water porpoises along a vapor phase-liquid curve. This point is determined to be between 70-100 psi within a temperature range of 265° F.-305° F. This process technique substantially improves the permeation of the iron acetate chemistry into the inner reaches of the ground tire rubber fragment.

### Exemplary Example 5

### Asphalt Modifier

The product of Exemplary Example 3 (“test PTR”) is tested for use as an asphalt modifier, e.g., for use as a binder in hot mix and as an emulsion base for paving applications. A sample of paving asphalt is obtained.

Initial solubility and separation testing is conducted by dispersing the test PTR in Raffex 200 process oil (“test process oil”) to yield a 50% by weight mixture. The blend is easily flowable at room temperature through the micro-compounder. The resulting mixture of test PTR and test asphalt exhibits a solubility >99% and a separation remaining at or above minimums for the PG 64-10 standard are achieved.

The test process oil has an ambient viscosity similar to that of 40 weight motor oil, such that a mixture of test PTR and test asphalt is expected to significantly dilute the asphalt, impacting high temperature performance. A mixture of 40 parts by weight test PTR 40 to 10 parts by weight Raffen 200 to 50 parts by weight test asphalt is expected to improve the high temperature performance to, e.g., PG76, but may require adjustments to the polymer to maintain acceptable cold temperature properties.

### Exemplary Example 6

### Asphalt Modifier

A sample of the test asphalt is warmed at a temperature at or below 275° F. for less than one hour (referred to as “test base” or “SJR PG 64-10 Base”), then blended with the test PTR at a weight ratio of 15 parts test PTR and 85 parts test asphalt to yield a mixture (referred to as “test mixture”, “PTR PG 64-10”, or “Prism PG 64-10”). The test base and the test mixture are subjected to testing to determine compliance to the Caltrans specification for PG 64-10 asphalts including specific gravity and multiple stress creep recovery (MSCR). The test mixture is also subjected to separation testing. The base sample is tested to determine specification compliance as prescribed by AASHTO M320. Additional tests required by the Caltrans PG specification are also performed. The test mixture is stirred for 10 minutes at 300° F. using a Silverson Mixer to ensure homogeneity. The test mixture is then tested for grade determination as per AASHTO R29. Additional tests required by Caltrans PG specification are also performed. The MSCR testing is performed as per AASHTO T350. The separation test is performed by pouring the sample into a cigar tube and storing the sample at 325° F. (163° C.) for 48 hours. The top and bottom third of the tube are then tested for Dynamic Shear Rheology (SDR). The test mixture is determined to be suitable for use as an asphalt modifier, and exhibits compliance with the Caltrans PG specification.

### Exemplary Example 7

### Morphology of PTR

The product streams generated by a method conducted in an alternate batch mode process utilizing a stirred pressure vessel are observed after numerous runs. It is observed that tiny, golden fibers with a cross section of about 0.002 inches-0.005 inches, and of a variable length, are present within the interlinked substituted rubber material. The fibers are expected to only be destroyed by excessive heat (temperatures higher than those employed in the interlinked substitution process described herein, and higher than those characteristic of hot mix processes) and will not dissolve in trichloroethylene (TCE).

The fibers' presence can be expected to not add significant mass to the insoluble component of the sub-micron interlinked substituted rubber material but it is expected to plug a one-micron filter pore, making the actual filter medium less porous, and thereby leading to a false reading of the filtrate concentration quanta. Samples of interlinked substituted rubber material in a form of a slurry are passed through a high temperature-high pressure piston-diaphragm pump and through a high strength, sintered filter capable of handling up to 50,000 psi through a 1.0 micron orifice. This further processing, which is believed to reduce the overall length of the fibers, yields a smooth mixture capable of passing through a one-micron filter pore. The further processing readily disintegrates the rubber into an easily dispersible, sub-micron moiety, with some release of carbon black.

This fiber component derived from recycled tire greatly improves the strength of the bond between the asphalt to which the interlinked substituted rubber material is added (e.g., as a binder or adhesive) and the aggregate, thereby improving overall pavement performance, yielding a superior pavement when compared to one prepared from aggregate and asphalt containing virgin rubber.

### PTR in Black Master Batch

Interlinked substituted rubber material, generated using lab scale equipment is added to a known-property base black master batch of virgin rubber at an amount of 10 wt. %, (after adjustment for filler materials in the interlinked substituted rubber material). The resulting 10 wt. % mixture is subjected to thermogravimetric analysis and other testing. The resulting 10 wt. % mixture is observed to be near-equivalent in homogenizable, physical properties to the known-property base black master batch of virgin rubber, such that it will not affect the final performance of a new tire, or can be used in a base black master batch at a higher loading than the upper limit of 3 wt. % that has traditionally been employed for small-particle (200 mesh), fully-vulcanized, ground tire rubber. In other words, the interlinked substituted rubber material is observed to be suitable for use in fabricating tires as the sole rubber source, or it can be used in combination with base black master batch at loadings above 3%, e.g., 4, 5, 6, 7, 8, 9, 10, 15, 20, 25, 30, 35, 40, 45, 50, 55, 60, 65, 70, 75, 80, 85, 90, or 95 wt. % or more.

The interlinked substituted rubber material is observed to be near elemental sulfur-free, to have a morphology similar to composite virgin rubber, to be ≤50 micron in particle size, with substantial elastomer retention of the carbon black. The material is suitable for use as at least 20% and up to 50, 60%, 70, 80, 90%, or more (e.g., as much as 100%) of the sidewall of new, light truck and auto tires. Such an interlinked substituted rubber material is also suitable for use in membranes and industrial rubber goods.

### IPREX Rubber Polymer

lnterPenetrating Regenerative Elastomer Xlink (IPREX) Rubber Polymer (IRP) is a microlaminated, anisotropic structural rubber sheet. It is composed of multiple, vacuum-heat fused and cross linked layers, each being in the range of 10-70 microns thick. The material comprises carbon filled, interpenetrating polyisoprene-polybutadiene elastomer chains, regenerative, realigned crosslinks by transverse sulfidic bridges. The individual laminae exhibit a near-zero loop probability and bias-directional, parallel-reptated, intertwined, elastomer backbone structure(s) which, when progressively laid-up during construction at 30-45 degrees to the anisotropic ‘grain’ of each preceding laminae, produces a finished sheet exhibiting superior torsional strength and resilience to comparable isotropic sheets of similar material and cross-section thickness. Pre-cross linked feedstock is processed into thin laminae through a variable nip, high pressure roll mill. IPREX Rubber may be fabricated in two steps from previously cross linked, black master batch virgin feedstock prepared for tire or other engineered rubber products and/or EOL whole tire scrap which has subsequently been parted into small rubber particles (typically 30 mesh, ambient ground tire rubber), which are then subsequently re-compounded according to predetermined, PRISM Reactor process parameters as described herein. IPREX Rubber may be compounded to form an interpenetrating and cross linked, elastomer network with other elastomers, such as functionalized SiR, for enhanced chemical and heat resistance. IPREX rubber is suitable for use in tire wall construction, code compliant electrical tape and potting compounds, industrial belting and hoses, high temperature fabrics and gaskets, geo-liners, roofing and waterproofing membranes, colloidal suspensions for industrial adhesives, and super-pave, PG hot-melt, asphalt binder modification.

### Post-Reactor GTRP-Containing Vehicle Tire Performance

The post-reactor GTRP has a clumpy, non-uniform appearance exiting the reactor. After drying and compounding with cross-link agents and other optional hybrid elastomers, typically accomplished in a high shear, internal mixer such as a twin arm Banbury mixer, a rotor-stator mixer, sigma blade mixer, batch high shear mixer, inline high shear mixer, the GTRP is passed through a narrow, roll mill nip where it becomes a thin sheet. This thin sheet, unlike conventional, virgin, black master batch (VBMB) elastomer composite compounds, similarly processed, may exhibit an anisotropy in length tensile strength to width tensile strength of up to approx. 3:1. The factors that may contribute to the degree of anisotropy include the reactor-controlled loop probability reduction, manipulation of the degree of crosslink dislocation, and/or reduction of internal mixing time.
Reactor Controlled Loop Probability Reduction

This factor can statistically add, on average, 12.5% by weight of additional, effective elastomer to the resulting matrix, inasmuch as once the same-backbone, methyl carbocation precursor-bonded, sulfuric bridge is dislocated, the elastomer is released to dynamically orient (and remain so) as a reptation-bias, along the lateral axis of compression-travel (which is perpendicular the face of the roll mill nip).
Manipulation of the Degree of Cross Link Dislocation

The resilience of remaining, EOL tire cross-links induce a variable, residual resistance to size reduction during compounding and final sheet preparation, wherein the not-fully dislocated particle resists being flattened by the roll mill pressure. This appendage acts as an anchor, being drug along by that portion of the elastomer matrix that more readily achieves reptate-like dynamics. The effect is a reptate-bias in the lateral direction of compression-travel between the rolls.
Reduction of Internal Mixing Time

Post-reactor, GTRP particle, final particle size reduction is a function of the number of wiping cycles the particle endures within the mixer (e.g., twin arm mixer). Since typically only minimal amounts of additives are employed to prepare the GTRP for milling into a sheet for many applications, excessive high shear is not necessitated except when the taking the clumps into progressively smaller dimensions is desired. This manipulation in mixing time can have a similar, but slightly less pronounced, dragging-anchor-effect to that previously described herein.

Where isotropism is advantageous, the GTRP can be handled in a manner which is the inverse of these three discriminators. However, unlike VBMB, the anisotropic quality can have great advantage in structures which must undergo persistent flexing, yet remain dimensionally stable, such as the sidewall of a vehicle tire.

### Treated Rubber for Tire Applications

Industry averages place approx. 15% of the vehicle's operational fuel consumption upon overcoming the rolling resistance of the vehicle tire. Most of that resistance is due to tire squirm as, with each revolution, the tread wanders back and forth in an irregular, sinusoidal pattern to the direction of travel as the tread section comes in contact with the pavement. This distortion is restrained by the resilient, torsional properties of the tire sidewall, transmitted to the solid rim and suspension of the vehicle. Tire manufacturing design and construction utilizes a reinforcement fabric, placed at 15-90 degrees to the vertical, rolling tire plane, which is laminated between the isotropic VBMB to achieve a composite structure that maintains a safe, effective rolling structure. However, it takes significant energy to overcome the broad range of torsional mechanics associated with traveling over a variety of surface conditions at variable speeds.

A 40 mil (˜1 mm) thick micro-laminated, GTRP sheet, composed of four 0.010″ thick sheets laid-up as a four, micro-ply assembly, with each sub-ply placed at approximately 45 degrees to the succeeding laminate, demonstrates an increase of approximately 30% or more in resistance to torsional distortion as compared to a similarly prepared VBMB micro-laminate. Using quantified foot-pound force, torsional mechanical models, a tire construction utilizing this anisotropic micro-laminate, particularly as a component in the two outer-most laminates of tire construction, where the stress from dimensional radius of distortion is the greatest, predicts rolling resistance reduction per unit of tire carcass weight of between 9.5% and 16%. A ten percent (10%) reduction in tire rolling resistance, based upon current global fuel consumption, equates to an annual savings of over six billion gallons (6,000,000,000 gal) of fuel. Accordingly, the treated rubber of the embodiments is particularly useful in tire applications, e.g., as microlaminated sheets (e.g., 2-100 or more sheets, e.g., 2-20, 2-20, or 2-5 sheets laminated together) for use in tire sidewall applications.

### Uses of Rubber Products

The rubbers and rubber-containing materials of the various embodiments may be manufactured, e.g., into articles or useful materials. In certain embodiments, rubber and rubber goods meeting one or more MIL-R specification are provided. The articles (e.g., engineered articles) can include but are not limited to tire tread, tire sidewall, roofing membrane, high dielectric electrical tape, tank lining, reservoir lining, trench lining, bridge underlayment, foundation waterproofing, parking garage waterproofing, hose, belt, molding, or other rubber goods prepared from molded rubber or rubber sheeting (e.g., gaskets, tubing, shock absorbing materials, floor mats and bed liners for vehicles, mats and flooring materials for commercial and residential construction, underlayments for floors, decking, and concrete, sound proofing, etc.). Other products include elasticized bands in clothing and hair ties, dishwashing gloves, toys, jar seals and tires, welcome mats, garden hoses. Other household rubber items include shoe soles, boots, raincoats, pond liners, mattresses and cushions, pillows, grips on garden tools, bathtub plugs, doorstops, earplugs, hot water bottles, aquarium tubing, faucet washers and backing for rugs. Stoppers for lab flasks and vials, chemical resistant mats and pads, prosthetics and other specialized products and equipment can be made from the rubber of the embodiments, as can rubber food and water bowls, chew toys and balls, foam rubber mattress pads, stall mats, elasticized vet wraps, flea collars, shed mitts and rubber combs, mouse pads, keyboards, adhesives and rolling chair wheels, anti-fatigue mats, carpet underlayment, head phone pads and rubber stamps, inflatable beds for camping, playground tiles, rubber ducks, sportswear, scuba suits, vehicle components for civilian and military use; boat, ship, and submarine components for civilian or military use; airplane, passenger plane, and fighter jet components, railcar and train engine components, residential and commercial building products, factory or industrial or manufacturing components, clothing and footwear components.

### Exemplary Methods and Elastomers

Method 1: A method for preparing a rubber-based elastomer, comprising: applying pressure to a mixture comprising sulfur-crosslinked rubber particles and particles of a digenite lattice of copper sulfide, then releasing the pressure, whereby a resident sulfur in a rubber crosslink of the sulfur-crosslinked rubber particles is transferred to the digenite lattice of copper sulfide, whereby a rubber-based elastomer is obtained.

Method 2: Method 1, wherein the particles of the digenite lattice of copper sulfide are provided in a carrier comprising oleic acid ligand, and wherein the oleic acid ligand reduces the resident sulfur in the rubber crosslink prior to its transfer to the digenite lattice of copper sulfide.

Method 3: Method 2, wherein the oleic acid ligand is provided in a form of soy oil containing 22% by weight oleic acid component.

Method 4: Method 2 or 3, wherein the particles of the digenite lattice of copper sulfide and the carrier are mixed at a weight ratio of 1:4 prior to mixing with the sulfur-crosslinked rubber particles.

Method 5: Any one of Methods 1-4, wherein the particles of the digenite lattice of copper sulfide are provided in a mixture with a stabilizer, optionally silica particles.

Method 6: Method 5, wherein the silica particles are nanoparticles of approx. 160 m²/g surface area.

Method 7: Method 5 or 6, wherein the particles of the digenite lattice of copper sulfide and the carrier are mixed at a weight ratio of 1:4 to yield an OMC-1, and wherein the OMC-1 is combined with the stabilizer at a weight ratio of 1:5 to yield a mixture of OMC-1 and stabilizer.

Method 8: Method 7, wherein the mixture of OMC-1 and stabilizer is combined with sulfur-crosslinked rubber particles in a weight ratio of 4:96.

Method 9: Method 8, wherein the sulfur-crosslinked rubber particles are in a form of ground tire rubber having an average particle size of approx. 600 microns.

Method 10: Method 9, wherein the ground tire rubber is end-of-life tire rubber.

Method 11: Any one of Methods 1-10, wherein the particles of the digenite lattice of copper sulfide are provided in a mixture with a stabilizer, optionally silica particles.

Method 12: Any one of Methods 1-11, wherein the particles of digenite lattice of copper sulfide are prepared by reacting metallic copper with sulfur at a temperature of 155° C. in a closed, vented ceramic vessel, and capturing escaping copper sulfide in an activated carbon filter, optionally subjecting the copper sulfide to hydro-quenching to achieve a particle size of <100 nm.

Method 13: Method 12, wherein the copper is 99% by weight pure copper metal in a form of wire or particles and wherein the sulfur is in a form of 99% by weight pure precipitated sulfur.

Method 14: Any one of Methods 1-13, wherein the digenite lattice of copper sulfide is converted to a covellite phase of copper sulfide.

Method 15: A method for preparing a rubber-based elastomer, comprising: applying pressure to a mixture comprising sulfur-crosslinked rubber particles and iron (II) acetate, then releasing the pressure, whereby a rubber-based elastomer is obtained.

Method 16: Method 15, wherein the iron (II) acetate is present in the mixture at from 1 to 5% by weight of the mixture.

Method 17: Method 15, wherein the iron (II) acetate is present in the mixture at about 2% by weight of the mixture.

Method 18: Method 15, wherein the sulfur-crosslinked rubber particles are in a form of ground tire rubber having an average particle size of approx. 600 microns.

Method 19: Method 15, wherein the ground tire rubber is end-of-life tire rubber.

Method 20: Any one of Methods 15-19, further comprising preparing a mixture comprising the rubber-based elastomer and copper (II) acetate, applying pressure to the mixture of the rubber-based elastomer and copper (II) acetate, then releasing the pressure, whereby a reduced particle size rubber-based elastomer is obtained.

Method 21: Method 20, wherein the iron (II) acetate is present in the mixture comprising sulfur-crosslinked rubber particles and iron (II) acetate at about 1.5% by weight of the mixture, and wherein the copper (II) acetate is present in the mixture comprising rubber-based elastomer and copper (II) acetate at about 0.5% by weight of the mixture comprising rubber-based elastomer and copper (II) acetate.

Method 22: Any one of Methods 1-22, wherein the mixture is subjected to microwave radiation.

Method 23: Any one of Methods 1-22, wherein the pressure is generated into a co-rotating reactor, optionally a co-rotating reactor comprising an annular cavity wherein a series of rotating lobes create pressure impingement upon the mixture as it progresses through the co-rotating reactor.

Method 24: Any one of Methods 1-22, wherein the pressure is generated by co-rotating reactor compression bars adapted to subject the mixture to pressure pulses.

Method 25: Any one of Methods 1-22, wherein pressure is applied by passing the mixture through a multi-lobe, co-rotating mixer extruder.

Method 26: Any one of Methods 1-25, wherein pressure is applied in a series of pulses, wherein each particle of the mixture encounters 120,000 or more pulses in production of the rubber-based elastomer.

Method 27: Any one of Methods 1-22, wherein pressure is applied by passing the mixture between two rollers.

Method 28: Method 27 wherein the mixture passes between the two rollers from 3 to 100 times.

Method 29: Any one of Methods 27 or 28, wherein the mixture passes between the two rollers from 3 to 10 times.

Method 30: Any one of Methods 27-29, wherein the mixture passes between the rollers from 3 to 5 times.

Method 31: Any one of Methods 27-30, wherein the two rollers have a nip of 0.007 inches to about 0.050 inches.

Method 32: Any one of Methods 27-31, wherein one of the two rollers rotates faster than the other.

Method 33: Any one of Methods 27-32, wherein one of the two rollers rotates faster than the other, optionally up to 1.15 times faster than the other.

Method 34: Any one of Methods 27-33, wherein one of the two rollers has a variable speed of from 5 to 150 rpm.

Method 35: Any one of Methods 27-34, wherein the two rollers have a variable speed of from 5 to 150 rpm.

Method 36: Any one of Methods 1-35, wherein pressure is applied in a series of pulses, wherein a temperature of the mixture rises to over 200° C. at a peak pressure in a pulse and then subsides until a next pulse.

Method 37: Any one of Methods 1-36, wherein the pressure is from 100-400 megapascals.

Method 38: Any one of Methods 1-37, wherein the mixture further comprises one or more of a virgin rubber or a virgin elastomer or a synthetic rubber.

Method 39: Any one of Methods 1-38, wherein the mixture is processed in a continuous three-step process comprising: dry coating ground tire rubber particles with at least one organometallic compound selected from copper sulfide, iron (II) acetate, and copper (II) acetate in a spray-mixing auger/pugmill to obtain dry-coated ground tire rubber particles; feeding the dry-coated ground tire rubber particles through a co-rotating lobed bar compression gauntlet to obtain processed particles; and squeezing processed particles with a screw through a high shear knife-die assembly, whereby a rubber-based elastomer comprising 50-75 micron sized rubber particles is obtained.

Method 40: Any one of Methods 1-38, wherein the mixture is processed using a single screw extruder, armed with one or more tiny orifice breaker plates, and run at pressures of from 400-600 bars, whereby a rubber-based elastomer comprising approximately 10 micron sized rubber particles is obtained.

Method 41: Any one of Methods 1-38, wherein the mixture is processed in a continuous three-step process comprising: dry coating ground tire rubber particles with at least one organometallic compound selected from copper sulfide, iron (II) acetate, and copper (II) acetate in a spray-mixing auger/pugmill to obtain dry-coated ground tire rubber particles; feeding the dry-coated ground tire rubber particles through a co-rotating lobed bar compression gauntlet to obtain processed particles; and squeezing processed particles with a screw through a high shear knife-die assembly, whereby a rubber-based elastomer comprising 50-75 micron sized rubber particles is obtained.

Method 42: Any one of Methods 1-38, wherein the mixture is processed in a continuous three-step process comprising: Combining ground tire rubber particles with water and at least one organometallic compound selected from copper sulfide, iron (II) acetate, and copper (II) acetate in a spray-mixing auger/pugmill to obtain a mixture; feeding the mixture through a co-rotating lobed bar compression gauntlet to obtain processed rubber; and squeezing the processed rubber with an auger through a high shear knife-die assembly, whereby a rubber-based elastomer comprising <1 micron sized rubber particles is obtained.

Method 43: Method 42, wherein the mixture comprises 1-10% by weight water.

Method 44: Method 43, wherein the mixture comprises 5% by weight water.

Method 45: Any one of Methods 43-44, wherein a controlled but moving pack-seal composed of the processed rubber is formed between an end of the auger and a backside of the knife attached to the auger, which impinges the processed rubber into a twisting, high viscosity flow propelled between the mechanical ramming forces generated by material from the auger, whereupon the temperature rises from near ambient to 300° F. or higher.

Method 46: Any one of Methods 43-45, wherein an impingement zone formed between an end of the auger and a backside of the knife attached to the auger functions as a hydro-cracking retort that fractures the processed rubber into the rubber-based elastomer comprising <1 micron sized rubber particles.

Method 47: Any one of Methods 43-46, further comprising finishing the rubber-based elastomer comprising <1 micron sized rubber particles through calendar rolls into a film composed substantially of <1 micron sized rubber particles.

Elastomer 48: An elastomer prepared by the method of any of the aforementioned claims.

Elastomer 49: Elastomer 48, wherein the elastomer is subjected to cross-linking.

Elastomer 50: Any one of Elastomers 48-49, wherein the elastomer is fabricated into a rubber-containing article.

Elastomer 51: Elastomer 50, wherein the rubber-containing article is a new tire.

Elastomer 52: Elastomer 50, wherein the rubber-containing article is an engineered rubber article.

Method 53: A method for preparing a rubber-based elastomer, comprising: applying pressure to a mixture comprising sulfur-crosslinked rubber particles and iron (II) acetate, then releasing the pressure, whereby a rubber-based elastomer is obtained.

Method 54: Method 53, wherein the iron (II) acetate is present in the mixture at from 1 to 5% by weight of the mixture.

Method 55: Method 53, wherein the iron (II) acetate is present in the mixture at about 2% by weight of the mixture.

Method 56: Method 53, wherein the iron (II) acetate is present in the mixture at from about 1-1.5% by weight of the mixture.

Method 57: Method 53, wherein the iron (II) acetate is provided in an aqueous solution.

Method 58: Method 57, wherein the solution of iron (II) acetate in water is combined with the sulfur-crosslinked rubber particles and the pressure applied within 15 minutes of the iron (II) acetate being dissolved in water.

Method 59: Method 57, wherein the aqueous solution has a pH above 7.

Method 60: Method 59, wherein the aqueous solution has a pH of about 8.

Method 61: Method 57, wherein 2 parts by weight water is present to 1 part by weight sulfur-crosslinked rubber particles in the mixture.

Method 62: Method 61, wherein the rubber-based elastomer is combined with asphalt as an asphalt modifier.

Method 63: Method 57, wherein 1 part by weight water is present to 20 parts by weight sulfur-crosslinked rubber particles in the mixture.

Method 64: Method 63, wherein the mixture further comprises a virgin elastomer.

Method 65: Method 64, wherein the virgin elastomer comprises natural rubber, styrene-butadiene rubber, or a mixture thereof.

Method 66: Method 65, wherein the rubber-based elastomer is molded into a molded rubber product.

Method 67: Method 53, wherein the sulfur-crosslinked rubber particles are in a form of ground tire rubber having an average particle size of approx. 600 microns.

Method 68: Method 67, wherein the ground tire rubber is end-of-life tire rubber.

Method 69: Method 53, wherein the mixture further comprises a reducing agent.

Method 70: Method 69, wherein the reducing agent comprises ammonia.

Method 71: Method 53, wherein applying pressure occurs in a high shear mixer.

Method 72: Method 53, further comprising preparing a mixture comprising the rubber-based elastomer and copper (II) acetate, applying pressure to the mixture of the rubber-based elastomer and copper (II) acetate, then releasing the pressure, whereby a reduced particle size rubber-based elastomer is obtained.

Method 73: Method 72, wherein the iron (II) acetate is present in the mixture comprising sulfur-crosslinked rubber particles and iron (II) acetate at about 1.5% by weight of the mixture, and wherein the copper (II) acetate is present in the mixture comprising rubber-based elastomer and copper (II) acetate at about 0.5% by weight of the mixture comprising rubber-based elastomer and copper (II) acetate.

Method 74: A method for preparing a rubber-based elastomer, comprising: applying pressure to a mixture comprising sulfur-crosslinked rubber particles and particles of a digenite lattice of copper sulfide, then releasing the pressure, whereby a resident sulfur in a rubber crosslink of the sulfur-crosslinked rubber particles is transferred to the digenite lattice of copper sulfide, whereby a rubber-based elastomer is obtained.

Method 75: Method 74, wherein the particles of the digenite lattice of copper sulfide are provided in a carrier comprising oleic acid ligand, and wherein the oleic acid ligand reduces the resident sulfur in the rubber crosslink prior to its transfer to the digenite lattice of copper sulfide.

Method 76: Method 75, wherein the oleic acid ligand is provided in a form of soy oil containing 22% by weight oleic acid component.

Method 77: Method 75, wherein the particles of the digenite lattice of copper sulfide and the carrier are mixed at a weight ratio of 1:4 prior to mixing with the sulfur-crosslinked rubber particles.

Method 78: Method 74, wherein the particles of the digenite lattice of copper sulfide are provided in a mixture with a stabilizer, optionally silica particles.

Method 79: Method 78, wherein the silica particles are nanoparticles of approx. 160 m²/g surface area.

Method 80: Method 78, wherein the particles of the digenite lattice of copper sulfide and the carrier are mixed at a weight ratio of 1:4 to yield a suspension, and wherein the suspension is combined with the stabilizer at a weight ratio of 1:5 to yield a mixture.

Method 81: Method 80, wherein the mixture of the suspension and the stabilizer is combined with sulfur-crosslinked rubber particles in a weight ratio of 4:96.

Method 82: Method 81, wherein the sulfur-crosslinked rubber particles are in a form of ground tire rubber having an average particle size of approx. 600 microns.

Method 83: Method 82, wherein the ground tire rubber is end-of-life tire rubber.

Method 84: Method 83, wherein the particles of digenite lattice of copper sulfide are prepared by reacting metallic copper with sulfur at a temperature of 155° C. in a closed, vented ceramic vessel, and capturing escaping copper sulfide in an activated carbon filter, optionally subjecting the copper sulfide to hydro-quenching to achieve a particle size of <100 nm.

Method 85: Method 84, wherein the copper is 99% by weight pure copper metal in a form of wire or particles and wherein the sulfur is in a form of 99% by weight pure precipitated sulfur.

Method 86: Method 5, wherein the digenite lattice of copper sulfide is converted to a covellite phase of copper sulfide.

Method 87: A method for preparing a rubber-based elastomer, comprising: applying pressure to a mixture comprising sulfur-crosslinked rubber particles and an alkaline earth metal acetate, then releasing the pressure, whereby a rubber-based elastomer is obtained.

Method 88: Method 87, wherein the alkaline earth metal acetate is magnesium acetate.

Method 89: Method 87, wherein the alkaline earth metal acetate is calcium acetate.

Elastomer 90: An elastomer prepared by Method 53.

Elastomer 91: Elastomer 90, wherein the elastomer is subjected to cross-linking.

Elastomer 92: Elastomer 90, wherein the elastomer is fabricated into a rubber-containing article.

Elastomer 93: Elastomer 92, wherein the rubber-containing article is a new tire.

Elastomer 94: Elastomer 92, wherein the rubber-containing article is an engineered rubber article.

While the disclosure has been illustrated and described in detail in the drawings and foregoing description, such illustration and description are to be considered illustrative or exemplary and not restrictive. The disclosure is not limited to the disclosed embodiments. Variations to the disclosed embodiments can be understood and effected by those skilled in the art in practicing the claimed disclosure, from a study of the drawings, the disclosure and the appended claims.

All references cited herein are incorporated herein by reference in their entirety. To the extent publications and patents or patent applications incorporated by reference contradict the disclosure contained in the specification, the specification is intended to supersede and/or take precedence over any such contradictory material.

Unless otherwise defined, all terms (including technical and scientific terms) are to be given their ordinary and customary meaning to a person of ordinary skill in the art, and are not to be limited to a special or customized meaning unless expressly so defined herein. It should be noted that the use of particular terminology when describing certain features or aspects of the disclosure should not be taken to imply that the terminology is being re-defined herein to be restricted to include any specific characteristics of the features or aspects of the disclosure with which that terminology is associated. Terms and phrases used in this application, and variations thereof, especially in the appended claims, unless otherwise expressly stated, should be construed as open ended as opposed to limiting. As examples of the foregoing, the term ‘including’ should be read to mean ‘including, without limitation,’ ‘including but not limited to,’ or the like; the term ‘comprising’ as used herein is synonymous with ‘including,’ containing,' or ‘characterized by,’ and is inclusive or open-ended and does not exclude additional, unrecited elements or method steps; the term ‘having’ should be interpreted as ‘having at least;’ the term ‘includes’ should be interpreted as ‘includes but is not limited to;’ the term ‘example’ is used to provide exemplary instances of the item in discussion, not an exhaustive or limiting list thereof; adjectives such as ‘known’, ‘normal’, ‘standard’, and terms of similar meaning should not be construed as limiting the item described to a given time period or to an item available as of a given time, but instead should be read to encompass known, normal, or standard technologies that may be available or known now or at any time in the future; and use of terms like ‘preferably,’ preferred, ‘desired,’ or ‘desirable,’ and words of similar meaning should not be understood as implying that certain features are critical, essential, or even important to the structure or function of the invention, but instead as merely intended to highlight alternative or additional features that may or may not be utilized in a particular embodiment of the invention. Likewise, a group of items linked with the conjunction ‘and’ should not be read as requiring that each and every one of those items be present in the grouping, but rather should be read as ‘and/or’ unless expressly stated otherwise. Similarly, a group of items linked with the conjunction ‘or’ should not be read as requiring mutual exclusivity among that group, but rather should be read as ‘and/or’ unless expressly stated otherwise.

Where a range of values is provided, it is understood that the upper and lower limit, and each intervening value between the upper and lower limit of the range is encompassed within the embodiments.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity. The indefinite article “a” or “an” does not exclude a plurality. A single processor or other unit may fulfill the functions of several items recited in the claims. The mere fact that certain measures are recited in mutually different dependent claims does not indicate that a combination of these measures cannot be used to advantage. Any reference signs in the claims should not be construed as limiting the scope.

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

All numbers expressing quantities of ingredients, reaction conditions, and so forth used in the specification are to be understood as being modified in all instances by the term ‘about.’ Accordingly, unless indicated to the contrary, the numerical parameters set forth herein are approximations that may vary depending upon the desired properties sought to be obtained. At the very least, and not as an attempt to limit the application of the doctrine of equivalents to the scope of any claims in any application claiming priority to the present application, each numerical parameter should be construed in light of the number of significant digits and ordinary rounding approaches.

Furthermore, although the foregoing has been described in some detail by way of illustrations and examples for purposes of clarity and understanding, it is apparent to those skilled in the art that certain changes and modifications may be practiced. Therefore, the description and examples should not be construed as limiting the scope of the invention to the specific embodiments and examples described herein, but rather to also cover all modification and alternatives coming with the true scope and spirit of the invention.

What is claimed is:

1. A method for preparing a rubber-based elastomer, comprising:
applying pressure to a mixture comprising sulfur-crosslinked rubber particles and iron (II) acetate, then releasing the pressure, whereby a rubber-based elastomer is obtained.

2. The method of claim 1, wherein the iron (II) acetate is present in the mixture at from 1 to 5% by weight of the mixture.

3. The method of claim 1, wherein the iron (II) acetate is present in the mixture at about 2% by weight of the mixture.

4. The method of claim 1, wherein the iron (II) acetate is present in the mixture at from about 1-1.5% by weight of the mixture.

5. The method of claim 1, wherein the iron (II) acetate is provided in an aqueous solution.

6. The method of claim 5, wherein the solution of iron (II) acetate in water is combined with the sulfur-crosslinked rubber particles and the pressure applied within 15 minutes of the iron (II) acetate being dissolved in water.

7. The method of claim 5, wherein the aqueous solution has a pH above 7.

8. The method of claim 7, wherein the aqueous solution has a pH of about 8.

9. The method of claim 5, wherein 2 parts by weight water is present to 1 part by weight sulfur-crosslinked rubber particles in the mixture.

10. The method of claim 9, wherein the rubber-based elastomer is combined with asphalt as an asphalt modifier.

11. The method of claim 5, wherein 1 part by weight water is present to 20 parts by weight sulfur-crosslinked rubber particles in the mixture.

12. The method of claim 11, wherein the mixture further comprises a virgin elastomer.

13. The method of claim 12, wherein the virgin elastomer comprises natural rubber, styrene-butadiene rubber, or a mixture thereof.

14. The method of claim 13, further comprising molding the rubber-based elastomer into a molded rubber product.

15. The method of claim 1, wherein the sulfur-crosslinked rubber particles comprise ground end-of-life tire rubber having an average particle size of approx. 600 microns.

16. The method of claim 1, wherein the mixture further comprises a reducing agent.

17. The method of claim 16, wherein the reducing agent comprises ammonia.

18. The method of claim 1, wherein applying pressure occurs in a high shear mixer.

19. A method for preparing a rubber-based elastomer, comprising:
applying pressure to a mixture comprising sulfur-crosslinked rubber particles and particles of a digenite lattice of copper sulfide, then releasing the pressure, whereby a resident sulfur in a rubber crosslink of the sulfur-crosslinked rubber particles is transferred to the digenite lattice of copper sulfide, whereby a rubber-based elastomer is obtained.

20. A method for preparing a rubber-based elastomer, comprising:
applying pressure to a mixture comprising sulfur-crosslinked rubber particles and an alkaline earth metal acetate, then releasing the pressure, whereby a rubber-based elastomer is obtained.
